(19) United States
(12) Patent Application Publication
(10) Pub. No.: US 2024/0181604 A1
(43) Pub. Date: Jun. 6, 2024

(54) PLIERS

(71) Applicant: KNIPEX-Werk C. Gustav Putsch KG, Wuppertal (DE)

(72) Inventors: Mario MOSLER, Leichlingen (DE); Kevin LIEDTKE, Wuppertal (DE); Christian HOLZ, Schwerte (DE)

(73) Assignee: KNIPEX-Werk C. Gustav Putsch KG, Wuppertal (DE)

(21) Appl. No.: 18/285,875

(22) PCT Filed: Apr. 5, 2022
(86) PCT No.: PCT/EP2022/058986

§ 371 Date: Oct. 6, 2023

(30) Foreign Application Priority Data
Apr. 7, 2021 (DE) 10 2021 108 673.6
May 25, 2021 (DE) 10 2021 113 461.7

(51) Int. Cl. B25B 7/10; B25B 7/02

(52) U.S. Cl. CPC B25B 7/10; B25B 7/02

(57) ABSTRACT

Pliers are formed by two plier arms which cross one another by a joint bolt. One plier arm is movable and the other is stationary. Gripping portions are formed on one side of the bolt and jaws forming the pliers mouth are provided on the other. The movable plier arm has a longitudinal slot with a toothing and the movable arm penetrates the stationary plier arm. The toothing can be overrun by depressing the joint bolt for adjusting a mouth opening width. The penetrating plier arm is overlapped by the penetrated plier arm in an overlap region that extends substantially at right angles to an adjustment direction of the joint bolt in the longitudinal slot. The overlap region has a width corresponding to 0.5 times or more of the maximum degree of adjustment, and a length corresponding to 2 times or more of the maximum degree of adjustment.

### TECHNICAL FIELD

The invention relates to pliers with two pliers arms, which cross one another in a joint bolt having a joint bolt axis and of which one pliers arm is to be regarded as movable and the other as stationary, wherein gripping sections are formed on one side of the joint bolt and jaws, which cooperate as the mouth of the pliers, are provided on the other side of the joint bolt, wherein the movable pliers arm furthermore has a longitudinal slot with a toothing and the joint bolt located in a receptacle is movable out of a toothing engagement, wherein the movable pliers arm penetrates the stationary pliers arm, and wherein the longitudinal slot furthermore has an extent that, with the pliers closed, extends transverse to an orientation of the pliers arms on the gripping side.

The invention also relates to pliers with two pliers arms, which are pivotable about a rotational axis, and a pliers mouth formed by two jaws, wherein the pliers mouth has opposing working surfaces, namely a first working surface and a second working surface, which are provided with a toothing over a significant part of their length viewed from a free end of the jaws toward the rotational axis, and wherein pointed teeth have an orientation of the tooth tips in the direction of the rotational axis and other pointed teeth have an orientation of the tooth tips toward the free end of the jaws.

The invention furthermore relates to pliers with two pliers arms, which are pivotable about a rotational axis, and a pliers mouth, wherein the pliers mouth has working surfaces that are provided with a toothing and the pointed teeth have, with respect to an extent of the tooth tips in the working surface, an orientation in the direction of the rotational axis, wherein the teeth furthermore have a respective angle bisector, and wherein the angle bisectors extend, starting from the tooth tip and facing away from the pliers mouth, toward the free end of the jaws or toward the end of the pliers mouth on the joint side.

In addition, the invention relates to pliers with two pliers arms, which are pivotable about a rotational axis, and a pliers mouth, wherein the pliers mouth has working surfaces that are provided with a toothing and the pointed teeth have, with respect to an extent of the tooth tips in the working surface, an orientation in the direction of the rotational axis, wherein a penetration plane, which in a view, in which the rotational axis is depicted in the form of a point, is depicted in the form of a line, extends through the pliers mouth, wherein the penetration plane results from the fact that it extends, at a maximally closed adjustment of the pliers mouth, at a right angle to a longitudinal center line of a longitudinal slot for receiving an adjustable joint bolt or extends in such a way that the rotational axis extends within the penetration plane, wherein either in the case of the longitudinal slot an intersection point of the longitudinal center plane with the longitudinal center line is chosen in such a way or, if the rotational axis extends within the penetration plane, the orientation of the penetration plane is chosen in such a way that a contact of opposing working surfaces takes place for the first time on the free end of the jaws at a certain opening angle, wherein the tooth tips furthermore end with different perpendicular distance from the penetration plane and the teeth furthermore have an angle bisector, which includes an acute angle with the penetration plane, and wherein the acute angle is in the region, in which the angle bisector extends within the region of the pliers mouth, formed between the perpendicular and the rotational axis on one part of the teeth and between the perpendicular and the free end of the pliers mouth in another part of the teeth.

The invention also relates to pliers with two pliers arms, which are pivotable about a rotational axis, and a pliers mouth, wherein the pliers mouth has working surfaces that are provided with a toothing and the pointed teeth have an orientation in the direction of the rotational axis, wherein a polyline can be laid through the tooth tips, and wherein segments of the polyline furthermore include an angle with one another and polylines lie opposite of one another in an open position of the pliers mouth.

### PRIOR ART

Pliers of the type in question are known, for example, from U.S. Pat. No. 5,996,450 A or U.S. Pat. No. 5,752,419 A. The pliers known from U.S. Pat. No. 5,752,419 A have an adjustability with respect to the opening width, particularly in the closed position of the pliers mouth, wherein the joint bolt is to this end initially moved out of the toothing engagement into a greatest open position possible by pivoting the pliers arms and the movable pliers arm is then displaced in the longitudinal slot having the toothing, preferably together with the joint bolt. The toothing engagement between the longitudinal slot and the joint bolt is ultimately produced once again by pivoting back the pliers arms. In this case, a displacement of the geometric joint bolt axis accordingly takes place within the longitudinal slot. No fixed adjustment of an opening width is possible in the pliers known from U.S. Pat. No. 5,996,450 A.

There also exist pliers, in which the joint bolt can be engaged, as well as depressed in order to adjust the width of the mouth, wherein we refer in this respect to WO 2008/049850 A1 (US 2010/0064861 A1), in which the longitudinal slot extends in the orientation of the movable pliers arm when the pliers are closed. Such pliers may also have toothed working surfaces in the region of the pliers mouth. Pliers of this type are known, for example, from DE 20 2013 191 985 U1. In conventional universal pliers, such a toothed pliers mouth is usually also referred to as burner hole. In pliers that cannot be adjusted with respect to the width of the pliers mouth, the joint bolt axis may be formed by a rotational axis of a joint pin.

### SUMMARY OF THE INVENTION

In light of the above-described prior art, the invention aims to design pliers of the type in question advantageously with respect to their handling and operation.

According to a first inventive idea, this objective is potentially attained with pliers, in which it is proposed that the toothing can be overrun by depressing the joint bolt in order to adjust a mouth opening width, wherein the penetrating pliers arm, preferably the movable pliers arm, has an elongate overlap region, in which the penetrating pliers arm is overlapped on both sides by the penetrated pliers arm, preferably the stationary pliers arm, and wherein the overlap region essentially extends at a right angle to an adjustment direction of the joint bolt in the longitudinal slot, with a width that corresponds to 0.5-times the maximum degree of adjustment or more and with a length that corresponds to 2-times the maximum degree of adjustment or more.

A functionally safe design of the pliers, as well as ergonomically advantageous handling thereof, is achieved as a result of the proposed configuration. In the preferred embodiment, the joint bolt is moved into a release position in the direction of the joint bolt axis in order to release the toothing engagement. Such a load for displacing the joint bolt preferably is only exerted deliberately, e.g. as a result of a depression with the thumb, particularly with the thumb of the hand gripping the pliers. A pivoting movement of the pliers arms into a greatest open position possible is not required for adjusting the opening width of the pliers mouth.

The overlap region can be observed in a closed position of the pliers, furthermore preferably at a smallest adjustment of the mouth opening width.

If the overlapping regions of the penetrated pliers arm do not extend congruently in a top view of the pliers, in which a geometric longitudinal axis of the joint bolt is depicted in the form of a point, the greatest overlapping edge contour of the penetrated pliers arm defines the overlap region, wherein this edge contour may also be composed of an upper and a lower edge contour, which respectively has the greatest degree of overlap, and form a quasi-imaginary edge contour over a length of the overlap region.

The penetration region of the penetrated pliers arm preferably can also be realized uniformly in material with the pliers head and the gripping region of the penetrated pliers arm.

The joint bolt, which can be actuated by being depressed, preferably can have a counter toothing that can be engaged with the toothing of the oblong hole. In this case, two or more catch positions, preferably three or more different catch positions, for example up to five or eight different catch positions, e.g. four, six or seven different catch positions, and a corresponding number of mouth opening widths of the pliers can be adjusted along the longitudinal extent of the oblong hole having the toothing.

This actuation of the joint bolt for respectively releasing or producing the toothing engagement can also be realized in an ergonomically advantageous manner due to the preferred slender structural shape, which is achieved as a result of the chosen overlap in a transition area between the pliers region receiving the joint bolt and the gripping sections. The thusly achieved slender design in the area of the overlap region also allows easy handling of the pliers, for example in areas that are difficult to access.

Furthermore, the overlap region preferably is formed in a pliers arm region that essentially extends linearly, preferably in longitudinal the direction, i.e. perpendicular to the adjustment direction, and is delimited by widenings resulting in the two pliers arms, preferably by a widening for forming the pliers head with the joint formation on one end and by an outwardly directed offset of the pliers arm for forming the handle region on the other end.

The overlap region preferably has an essentially constant width over the described length. This width may deviate (be smaller or greater) in comparison to an averaged width over the length of the overlap region, for example, by up to 2%, but in any case by preferably less than 10%.

The width of the overlap region may correspond, for example, to between 0.5-times and 2-times the degree of adjustment and its length may correspond, for example, to between 2-times and 5-times or 10-times the degree of adjustment.

The pliers arm sections, particularly in this transition area between the pliers region receiving the joint bolt and the gripping sections, preferably can extend equidirectionally, particularly with regard to a respective center line that is formed centrally between the outer edges, which essentially extend perpendicular to the adjustment direction of the joint bolt. According to a preferred embodiment, these center lines of the pliers arm sections may essentially extend parallel to one another. In the context of the present invention, even the inclusion of an acute angle, for example, of 1 or 2 degrees and up to 10 or 15 degrees can be regarded as essentially equidirectional.

If the maximum degree of adjustment of the pliers arms relative to one another along the longitudinal slot amounts, for example, to approximately 10 mm, a length of the essentially equidirectional pliers arm sections transverse thereto may amount, for example, to approximately 20 to 30 mm.

The above-defined objective is potentially also attained in that both working surfaces respectively have teeth in their extent from the free end of the jaws to the rotational axis, wherein said teeth have tooth tips that are oriented in the direction of the rotational axis and are followed by additional teeth in the same working surface, wherein the tooth tips of these additional teeth are oriented toward the free end of the jaws, or vice versa, and wherein oppositely oriented groups of teeth furthermore are respectively formed opposite of one another on the first and the second working surface.

An advantageous torque transmission to a workpiece grasped between the jaws, e.g. a round bolt, is achieved as a result of the proposed orientations of the groups of teeth. The workpiece can be grasped by one tooth or multiple teeth with an orientation toward the free end of the jaws in the region of one working surface and by one tooth or multiple teeth with an orientation toward the rotational axis in the region of the other working surface. Furthermore, an improved torque transmission to the workpiece preferably can be achieved in that this workpiece is grasped in a transition area between two groups, the teeth of which are oriented differently, in the region of one working surface and optionally by a tooth tip that is oriented in the chosen rotating direction in the region of the other working surface.

The angle bisector concerns the angle between two flanks of a tooth in a view of a longitudinal slot through the pliers mouth. In this view, the flanks preferably can extend linearly. However, they may also have a convex or concave curvature. If the flanks have a curved extent, a geometric straight line from the tooth tip to a tooth root is decisive for the angle bisector. If a tooth root is not defined as such, a lowest point between two adjacent teeth can also be used as tooth root. If a flank initially extends straight starting from the tooth tip and then transforms into a curvature, only the straight section of the tooth flank can be used for delimiting the angle for the angle bisector.

In pliers with a pliers mouth that has the toothing, the above-defined objective is potentially attained in that, viewed from a free end of the working surfaces of the pliers mouth toward the rotational axis, a first group of teeth is initially formed on a first working surface of the pliers mouth, wherein the respective angle bisector of the teeth of this first group extends at an incline starting from the tooth tip and, facing away from the pliers mouth, toward the free end of the jaw, wherein this first group of teeth is followed by a second group of teeth, in which the respective angle bisector extends at an incline toward the end of the pliers mouth on the joint side, and wherein this second group of teeth is followed by a third group of teeth, in which the respective angle bisector once again extends at an incline toward the free end of the jaw.

The above-described first group does not necessarily have to be the absolutely first group of the pliers mouth. In any case, a second group and a third group according to the above-described design follow this defined first group.

At least three successive groups of teeth preferably are formed on the first working surface in its longitudinal extent starting from the end of the working surfaces of the pliers mouth facing away from the rotational axis or from the free end of the jaws, respectively, wherein adjacent groups have different orientations of the teeth with respect to the extent and incline of the angle bisector.

Furthermore, corresponding groups of teeth preferably are also formed on the opposite second working surface, wherein these grooves preferably are respectively positioned opposite of the groups of teeth on the first working surface. An opposed position particularly is realized if corresponding teeth groups of teeth simultaneously act upon a round part or multi-sided part grasped by the pliers. With respect to an overall length of a penetration plane that penetrates the pliers mouth, this may be realized, for example, on a part with an optionally greatest diameter, which corresponds to one fourth or one half of the aforementioned overall length, as described further below.

With respect to a plane such as a longitudinal center plane of the pliers, but in any case a penetration plane of the pliers mouth, acute angles may be formed between the angle bisector and a perpendicular to the plane in the region of the pliers mouth. With respect to the penetration plane, acute angles between the angle bisector and a perpendicular to the penetration plane may also be formed in the region of the pliers mouth. In this case, the penetration plane may be oriented perpendicular to a longitudinal center line of the longitudinal slot, in which the joint bolt can be displaced in order to adjust a mouth width, e.g. in accordance with pliers of the above-described design, or the penetration plane may also extend in such a way that the rotational axis extends within this plane. The orientation of such a penetration plane may furthermore be chosen in such a way that a first contact of the regions of the working surfaces formed in the region of the free end takes place in this penetration plane in the course of closing the pliers mouth.

The penetration plane may coincide with or also differ from the aforementioned longitudinal center plane.

The aforementioned geometric longitudinal center line is formed in an adjustment direction of the joint bolt in the longitudinal slot. The perpendicular thereto, on the orientation of which the penetration plane extends, may intersect the longitudinal center line within the extent of the longitudinal slot, but furthermore also in the region of an imaginary extension of the longitudinal center line extending beyond the delimitation of the longitudinal slot.

The longitudinal slot, in which the joint bolt can be adjusted, may also extend in a curved manner. In such instances, the longitudinal center line also extends in a curved manner, typically in the form of a segment of a circle with comparatively large diameter. In this case, the perpendiculararity to a tangent on the longitudinal center line is formed in the intersection point.

In this case, the free end is the region of the jaws, which preferably lies beyond a center of the pliers mouth formed in the longitudinal extent of the jaws facing away from the rotational axis. Furthermore, this free end may also be formed by additional working regions of the jaws, which in the closed position of the pliers follow the toothed pliers mouth in the direction of the jaw ends. These additional working regions may likewise be toothed, but alternatively also realized, for example, with a smooth surface.

The first contact of the working surfaces in the free end of the jaws may occur due to the direct abutment, for example, of tooth tips of both jaws. In this case, the closed position of the pliers may be reached simultaneously with this first contact. This first abutment may also occur merely due to a first, simultaneous contact of one or more teeth of both respective working surfaces, which is spaced apart in the direction of the penetration plane.

In the course of closing a pliers mouth, the one working surface practically can, assuming that the penetration plane already abuts thereon, displace the penetration plane until the required contact with the other working surface also takes in this case place, simultaneously with the first contact. This position of the penetration plane is then conceptually quasi-frozen during the following observation. The reference to the penetration plane accordingly should always be regarded as referring to the frozen state.

The aforementioned first contacts refer to the teeth of the pliers mouth located in a front region of the pliers mouth, which belongs to the free end of the jaws. With respect to an overall length of the penetration plane that penetrates the pliers mouth, this accordingly concerns preferably the front half of the overall length assigned to the free end.

A—first—contact of the penetration plane may also be formed by enveloping surfaces of the toothings, wherein said enveloping surfaces are in the above-described view respectively depicted in the form of polylines that linearly connect the tooth tips. This may be the case, in particular, on toothed working surfaces in the region of the free end, wherein said toothings engage into one another in the closed position of the pliers mouth. In this case, the first contact of the penetration plane by the working surfaces in the region of the free end accordingly takes place prior to reaching the closed position, wherein the contact of the corresponding working surfaces in the penetration plane furthermore may basically take place in a punctiform or laminar manner.

It is initially and without consideration of the penetration plane preferred that, viewed from the free end of the working surfaces of the pliers mouth toward the rotational axis, a first group of teeth is initially formed on the first working surface of the pliers mouth, wherein the acute angle of this first group of teeth is respectively formed between the perpendicular and the rotational axis, wherein this first group of teeth is followed by a second group of teeth, in which the acute angle is respectively formed between the perpendicular and the free end of the working surfaces of the pliers mouth, and wherein this second group of teeth is followed by a third group of teeth, the acute angles of which are once again formed between the perpendicular and the rotational axis.

At least two changes in the tooth orientation advantageously occur with respect to the longitudinal extent of the working surface, wherein the teeth of the first group tend to point—viewed in the direction of the pliers mouth—in the direction of the rotational axis, the teeth of the second group tend to point in the direction of the free end of the working surface and the teeth of the third group once again tend to point in the direction of the rotational axis due to the described orientation of the angle bisectors.

The acute angles may have values between approximately 0.5 and approximately 60 degrees or more, preferably approximately 1 to approximately 50 degrees, wherein angular ranges, for example, between approximately 5 and approximately 25 degrees or between approximately 30 and approximately 45 degrees preferably can be realized within one group whereas angular ranges, for example, between approximately 3 and approximately 20 degrees or between approximately 25 and approximately 50 degrees can be realized within another group.

Two groups of teeth with the described change in the tooth orientation are respectively also formed on the opposite working surface. In this case, one group of the second, opposite working surface may also comprise so many teeth that it lies opposite of multiple groups, e.g. two groups, of the first working surface.

Different effective areas can be formed in the pliers mouth due to the chosen orientation of the groups of teeth of both working surfaces, wherein a workpiece such as a screw can be advantageously acted upon, for example, in the counterclockwise direction by using one or two adjacent groups of correspondingly oriented teeth in one area and another area, which is offset relative to the aforementioned area, serves for advantageously acting upon a workpiece in the clockwise direction. A higher torque than in conventional designs can be transmitted due to the proposed alternating orientation of the groups of teeth. With respect to the handling of the pliers, a certain claw-type interlock between the teeth and the workpiece can be advantageously achieved such that, in the course of applying a torque of the same value, higher forces than in conventional solutions can be transmitted before the non-positive interlock between the workpiece and the teeth of the working surfaces breaks apart.

With respect to the transmission of the torque and the screwing direction, it is essential that opposing teeth of both working surfaces act upon the workpiece.

In pliers with a pliers mouth that has a toothing, the above-defined objective furthermore may, according to another inventive idea, be attained in that each of the described polylines has in any case two adjacent segments that, pointing toward the pliers mouth, include an angle of 170 degrees or less to, for example, 100 degrees with one another, in that segments of the other polyline lie opposite of these segments and, likewise pointing toward the pliers mouth, include an angle of 170 degrees or more to, for example, 190 degrees with one another, and in that each polyline contains two segments that, viewed in the same direction, include an angle of 190 degrees or more with one another.

An advantageous design of the pliers mouth with respect to the handling of the pliers is achieved due to the proposed arrangement and orientation of the pointed teeth. For example, the polylines of preferably both working surfaces can be altogether realized with an elongate sinusoidal shape and, with respect to a side view of the pliers mouth, have a wave crest and a wave trough, as well as a reversal point resulting between the wave trough and the wave crest. With respect to the penetration plane, a wave crest of the polyline of one working surface preferably lies opposite of the wave trough of the polyline of the other working surface.

As described above with reference to the angular orientation of the teeth, this can advantageously result in the formation of an area within the pliers mouth, which is designed for acting upon, for example, a screw or a bolt or the like in the counterclockwise direction, and the formation of another area, which is offset relative thereto and designed for acting upon, for example, a screw or a bolt in the clockwise direction.

In a side view or in a cross section through the region of the pliers mouth, in which cross section the geometric pivoting axis of the pliers arms is depicted in the form of a point, the above-described polyline preferably is formed by linearly connecting the tooth tips to one another.

The described characterizations with respect to the angle bisectors and with respect to the polylines may at the same time also be realized on the pliers mouth.

The characteristics of the above-described independent claims are essential to the invention individually, as well as in any combination with one another, wherein characteristics of an independent claim furthermore can be combined with the characteristics of another independent claim or with characteristics of multiple independent claims, as well as with only individual characteristics of one or more other independent claims.

The characteristics concerning the design of teeth of toothed working surfaces in the pliers mouth particularly can also be realized in otherwise known types of pliers such as, in particular, universal pliers (see, for example, FIG. 11 of WO 2017/134074 A1 or US 2019/00392141, respectively) or water pump pliers (see initially cited WO 2008/049850 A1 or US 2010/0064861 A1, respectively).

Other characteristics of the invention are frequently described below, as well as in the description of the figures, in their preferred association with the object of claim 1 and/or the other independent claim or with characteristics of other claims. However, they may also be important in association with only individual characteristics of claim 1 and/or the other independent claim or the respective other claim or independently.

According to a preferred embodiment of the adjustment of the penetrating and the penetrated pliers arm, a greater surface overlap of the pliers arm sections on the gripping side can initially be formed in any case in the course of the adjustment from a smaller to a greater mouth opening width. The altogether streamlined region of the pliers arm sections preferably always provides sound support of the arm sections on one another in any mouth width position. This results in improved handling of the pliers. The effect of the streamlining of this region preferably is even intensified at greater mouth opening widths. According to a preferred embodiment, the degree of the overlap—viewed in a direction transverse to the center lines of the pliers arm sections—can become greater as the opening width increases. Accordingly, an enlarged supporting surface of the pliers arm sections on one another is formed at a great opening width. The adjustment to a greater opening width of the pliers mouth can be advantageously realized by exerting pressure upon both pliers arms in the region of their overlap with a finger and by the thusly promoted displacement toward one another.

Once a mouth opening width that does not correspond to the smallest adjustable mouth opening width is exceeded, a reduction of the surface overlap of the pliers arm sections can optionally occur once again during a further displacement of the pliers arms in order to assume an even greater mouth opening width. A mouth opening region, in which a greatest surface overlap of the pliers arm sections is reached, furthermore a can be traversed during displacement of the pliers arms from a position with the smallest mouth opening width into a position with the greatest mouth opening possible width after the disengagement of the interlock in the oblong hole.

In preferred embodiments, an at least partial overlap of the pliers arm sections is formed in any mouth opening position of the pliers.

A width of the pliers in the region of the overlap preferably is also initially reduced during an adjustment from a closed position of the pliers to a greater mouth opening width, particularly during an adjustment of the pliers from a smallest mouth opening width in the direction of a greater mouth opening width. In this case, the smallest width of the pliers in the region of the above-described pliers arm sections is formed at the greatest overlap possible.

Furthermore, the width in the region of the thusly streamlined region preferably is significantly smaller than the width in the region of the jaws, as well as preferably in the region of the pliers arms, in the same direction at any mouth opening width—particularly referred to a closed position of the mouth. For example, the greatest width in the region of the above-described pliers arm sections may amount, for example, to approximately 0.3-times to 0.8-times, furthermore optionally to 0.4-times to 0.6-times, the width in the region of the jaws or the pliers arms, respectively. This results in the described waist shape in the region of the pliers arm sections.

In another embodiment, the stationary pliers arm may have a depression that is designed for the pressure actuation of the joint bolt, wherein a joint bolt axis preferably is arranged eccentrically to a geometric center axis of the depression an depression. The forms advantageous finger contact surface, particularly a thumb contact surface, for the advantageous actuation of the joint bolt. The joint is displaced linearly in the direction of the base of the depression in order to thereby release the toothing engagement.

In this case, the joint bolt axis may be offset relative to the center axis of the depression in the adjustment direction of the pliers mouth. This can result in a degree of offset relative to the above-described longitudinal center plane. The offset arrangement of the joint bolt axis advantageously contributes to a slender structural shape of the pliers as a whole.

The jaws may also have working regions that are provided with a toothing. This may concern a toothing of the above-described type.

In this case, the working regions may deepen, with respect to a longitudinal extent of the pliers mouth, toward the pliers tip such that an opening remains in a front view of the pliers mouth when the pliers are closed or when the pliers mouth is closed, respectively. Accordingly, a grasping opening, which preferably has a tooth contour, is formed on the face side in the region of the pliers mouth. It is advantageous with respect to the handling of the pliers that an object therefore can also be grasped and, for example, turned with the front side of the proposed pliers.

With respect to a specific design of the pliers mouth and, in particular, an advantageous torque transmission, it is proposed, according to an enhancement regarding the design and arrangement of the teeth of the first working surface, that a fourth group of teeth follows the third group of teeth, wherein the respective angle bisector of the teeth of the fourth group extends at an incline toward the end of the pliers mouth on the joint side.

Acute angles of the fourth group between the angle bisector and the perpendicular to the plane may be formed—viewed in the direction of the pliers mouth—between the perpendicular and the free end of the working surfaces of the pliers mouth.

This results in another change of the tooth orientation between this fourth group and the third group of teeth such that four groups of teeth preferably are provided over the length of the first working surface. The tooth tips of the teeth of the first and the third group preferably tend to point—viewed in the direction of the pliers mouth—in the direction of the rotational axis whereas the tooth tips of the teeth of the second and the fourth group preferably tend to point in the direction of the free end of the first working surface.

Two groups of teeth that essentially tend to be oriented equidirectionally are spaced apart in the longitudinal direction of the working region by a group of teeth that tends to be directed opposite thereto.

The acute angles of the teeth of the groups that tend to be oriented equidirectionally, e.g. the first and the third group or the second and the fourth group, may essentially be identical or lie within an essentially identical value range. In this respect, the acute angles of two groups with teeth that essentially are oriented equidirectionally may also lie within different value ranges, wherein the acute angle of one group lies, for example, within a value range between approximately 5 and approximately 25 degrees and the acute angle of another group lies within a value range, for example, between approximately 30 and approximately 45 degrees.

In addition, the value ranges may by all means partially overlap. For example, one value range may lie between approximately 5 and approximately 35 degrees and the value range of the other group of teeth, which are oriented equidirectionally, may lie between approximately 30 and approximately 45 degrees.

Groups of teeth with a certain orientation of the angle bisector or angular orientation preferably lie opposite of one another referred to the plane. With respect to a perpendicular projection of these groups on the described plane, these opposing groups may overlap completely or also only partially, for example, by one third or more to two thirds or more. Accordingly, a group of teeth of the second working surface, the tooth tips of which have a tendential orientation in the direction of the rotational axis, may at least partially lie opposite of a group of teeth of the first working surface, the tooth tips of which likewise have a tendential orientation in the direction of the rotational axis.

With respect to the opposed position, the tooth tips may be arranged offset to one another through the plane referred to the perpendicular. This may result in an arrangement of the teeth of both working surfaces “on gap,” wherein the tooth tip of a tooth of the first working surface essentially points, viewed perpendicular to the plane, in the direction of a tooth root surface between two teeth of the second working surface in said arrangement.

In another embodiment, the second working surface of the pliers mouth may be provided with a first group of teeth, in which the respective angle bisector of the teeth extends at an incline starting from the tooth tip and, facing away from the pliers mouth, toward the free end of the jaw, wherein said first group is followed by a second group of teeth, in which the respective angle bisector extends at an incline toward the end of the pliers mouth on the joint side.

The acute angle of the first group of the second working surface resulting from the incline may be respectively formed—viewed within the pliers mouth—between the perpendicular and the rotational axis, wherein the acute angle of the second group of the same working surface may be formed respectively between the perpendicular and the free end of the working surfaces of the pliers mouth.

Furthermore, the second group of teeth preferably can comprise two subgroups of teeth, namely a first subgroup that respectively has a small incline or small acute angles and a second subgroup that respectively has a greater incline or greater acute angles.

The second group of teeth preferably is assigned to an end region of the second working surface facing the rotational axis. An additional division of the second group into two subgroups results in a preferred arrangement, in which the subgroup with a smaller incline or smaller acute angles may be formed so as to face the transition area of the second group to the first group of the second working region, which essentially faces the free end.

A subgroup may comprise one, two or multiple teeth.

The values of the greater acute angles of the second subgroup preferably can correspond to approximately 1.5-times to 100-times, for example to approximately 3-times to 50-times, the values of the smaller acute angles of the first subgroup.

For example, the first subgroup of the second group in the region of the second working surface may have acute angles within a value range between approximately 0.5 degrees to 10 degrees, for example between approximately 1 and approximately 5 degrees, and the adjacent second subgroup may have acute angles within a value range between approximately 10 and approximately 45 degrees, for example between approximately 15 and approximately 40 degrees.

In addition, an angle bisector, particularly of a tooth in a transition area between two successive groups, may also essentially coincide with the perpendicular such that no angle or a zero degree angle is formed therebetween.

According to a preferred enhancement, a round bolt can be grasped by one or more oppositely arranged and oppositely oriented teeth of the first and the second working surface in a front region facing the free end of the jaws, as well as in a rear region of the pliers mouth facing the rotational axis, wherein teeth of different groups of teeth are respectively engaged with the round bolt in the front and the rear region, wherein the round bolt can be grasped in the rear region by two teeth, which are respectively assigned to one of the opposite working surfaces and the tooth tips of which extend in opposite directions, and wherein the round bolt likewise can be grasped in the front region by two teeth, which are respectively assigned to one of the opposite working surfaces and the tooth tips of which extend in opposite directions.

We refer to the preceding explanations with respect to a potential diameter of such a round bolt.

Furthermore, the above-described teeth of a working surface for grasping a workpiece such as a round bolt twofold in the front and in the rear region preferably are inclined in opposite directions. In addition, the tooth of the first working surface, which is assigned to the rear region, may be inclined equidirectionally to the tooth of the second working surface, which is assigned to the front region.

It is furthermore proposed that twofold grasping of the round bolt is in any case possible if the round bolt has a diameter that requires a pliers mouth opening of approximately 10 degrees for the aforementioned grasping of the round bolt in the front region or in the rear region.

Furthermore, this type of grasping may also be possible at other opening angles of the pliers mouth such as, for example, at a pliers mouth opening of up to 30 or 45 degrees, as well as preferably also in an opening position of less than 10 degrees or, depending on the design of the pliers mouth as a whole, even in a completely closed position of the pliers mouth. In this case, the respective pliers mouth opening is dependent on the diameter of the workpiece, e.g. a round bolt, as well as on the grasping position in the pliers mouth and accordingly on whether the workpiece is grasped in the pliers mouth in the front region located distant from the joint or in the rear region located near the joint. The arrangement of a round bolt in the front region of the pliers mouth may require a smaller pliers mouth opening than the arrangement of a round bolt with the same diameter in the rear region.

The orientation of the tooth tips can be advantageously defined by a different length of tooth flanks of the respective tooth, wherein the longer tooth flank is formed on the side of the tooth tip facing away from the rotational axis if the tooth tip is oriented in the direction of the rotational axis and the longer tooth flank is formed on the side of the tooth tip facing away from the free end of the jaws if the tooth tip is oriented toward the free end of the jaws.

In a view, in which the rotational axis is depicted in the form of a point, the tooth flanks are formed to both sides of the tooth tip, wherein the tooth flanks extend from the tooth tip up to a tooth root surface, in which a transition to the following tooth and its tooth flank is formed.

In the described view, the tooth flanks may extend linearly, but optionally also in a sectionally curved manner. In the case of a curved extent of the flanks, the length of the tooth flank may be defined by a straight line that connects the ends of the tooth flank. We also refer to the preceding explanations in this respect.

With respect to the disclosure, the ranges or value ranges or multiple ranges indicated above and below also include all intermediate values, particularly in 1/10 increments of the respective dimension, but optionally also dimensionless. For example, the indication 0.5-times to 3-times also includes the disclosure of 0.6-times to 3-times, 0.5-times to 2.9-times, 0.6-times to 2.9-times, etc., the disclosure of 170 degrees s also includes the disclosure of 169.9 degrees or less, etc., and the disclosure of 5 to 25 degrees also includes the disclosure of 5.1 to 25 degrees, 5 to 24.9 degrees, 5.1 to 24.9 degrees, etc. The respective disclosure may on the one hand serve for defining a lower and/or upper limit of a cited range, but alternatively or additionally also for disclosing one or more singular values from a respectively indicated range.

### BRIEF DESCRIPTION OF THE DRAWINGS

The invention is described in greater detail below with reference to the attached drawings that, however, merely show exemplary embodiments. A component, which is described with reference to one of the exemplary embodiments and not replaced with a different component in another exemplary embodiment, is therefore also described as a potentially existing component in this other exemplary embodiment. In the respective drawings:

FIG. 1 shows a perspective view of pliers of the type in question concerning a first embodiment;

FIG. 2 shows a front view of the pliers;

FIG. 3 shows a side view of the pliers according to the arrow III in FIG. 2;

FIG. 4 shows a rear view of the pliers;

FIG. 5 shows an enlarged detail of the region V in FIG. 2;

FIG. 6 shows a front view of the pliers according to the arrow VI in FIG. 6;

FIG. 7 shows an enlarged detail of the region VII in FIG. 6;

FIG. 8 shows a highly enlarged view of the region VIII in FIG. 2;

FIG. 9 shows an enlarged view of a pliers mouth corresponding to FIG. 8;

FIG. 10 shows an enlarged view of the region X in FIG. 9, in which one of the jaws is merely illustrated with dot-dash lines;

FIG. 11 shows a view corresponding to FIG. 10, in which the other jaw is merely illustrated with dot-dash lines;

FIG. 12 shows an enlarged view of the region XII in FIG. 9, in which one of the jaws is merely illustrated with dot-dash lines;

FIG. 13 shows a view corresponding to FIG. 12, in which the other jaw is merely illustrated with dot-dash lines;

FIG. 14 shows an enlarged section along the line XIV-XIV in FIG. 4;

FIG. 15 shows a view that essentially corresponds to FIG. 14 and concerns a joint bolt position for releasing an interlock;

FIG. 16 shows a section along the line XVI-XVI in FIG. 3 concerning a smallest mouth opening width of the pliers;

FIG. 17 shows a sectional view according to FIG. 16 concerning a medium mouth opening width of the pliers;

FIG. 18 shows another s sectional view that corresponds to FIG. 16 and concerns a greatest mouth opening width of the pliers;

FIG. 19 shows a view corresponding to FIG. 5 while grasping a workpiece in a front region of the pliers mouth;

FIG. 20 shows a view corresponding to FIG. 19 while grasping a workpiece in a rear region of the pliers mouth;

FIG. 21 shows a view of pliers according to a second embodiment;

FIG. 22 shows an enlarged detail of the region XXII in FIG. 21; and

FIGS. 23 to 26 show schematic views of alternative layout shapes of the pliers mouth.

### DESCRIPTION OF THE EMBODIMENTS

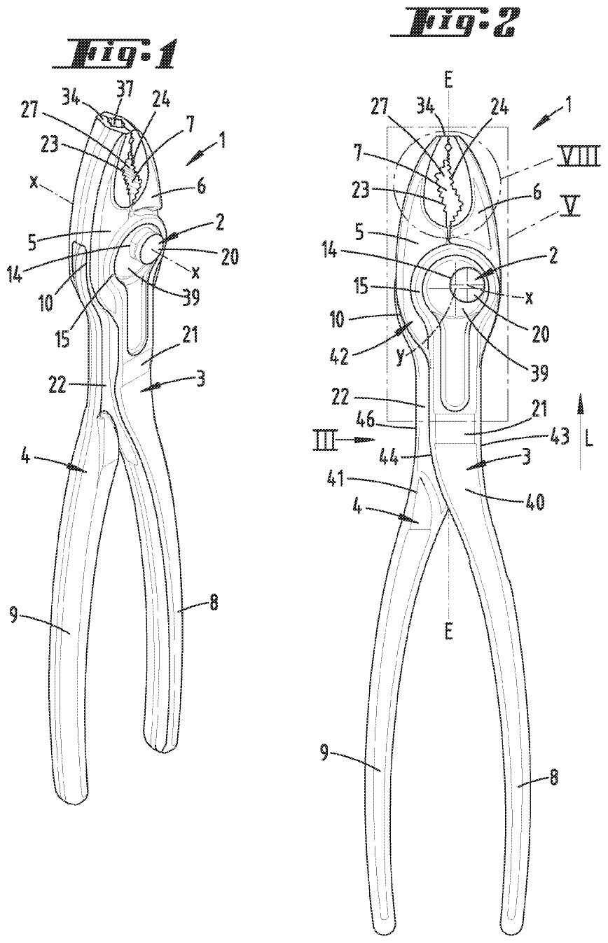

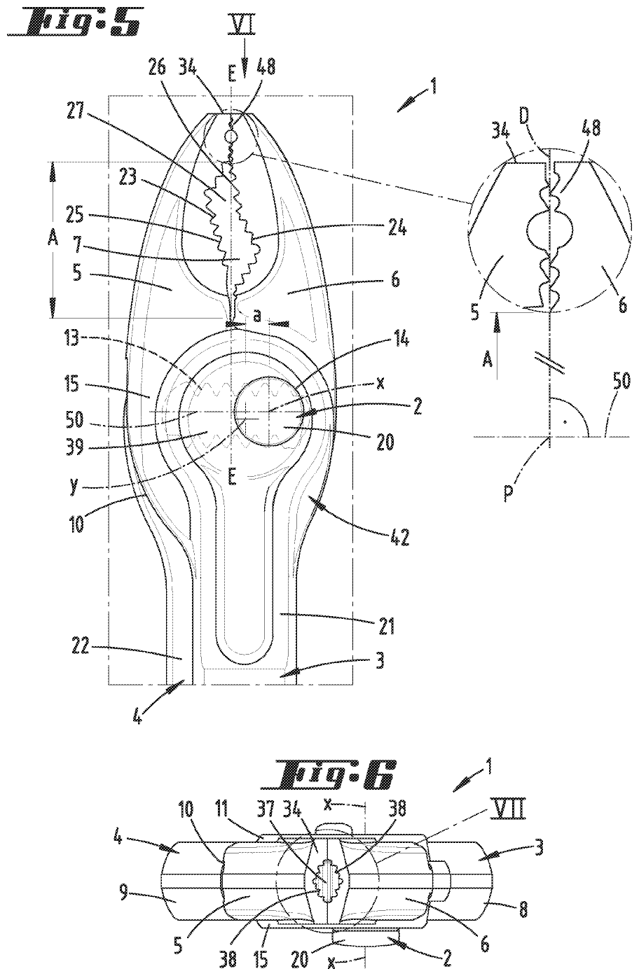

Pliers 1 in the form of assembly and/or gripping pliers are initially described with reference to FIGS. 1 to 4.

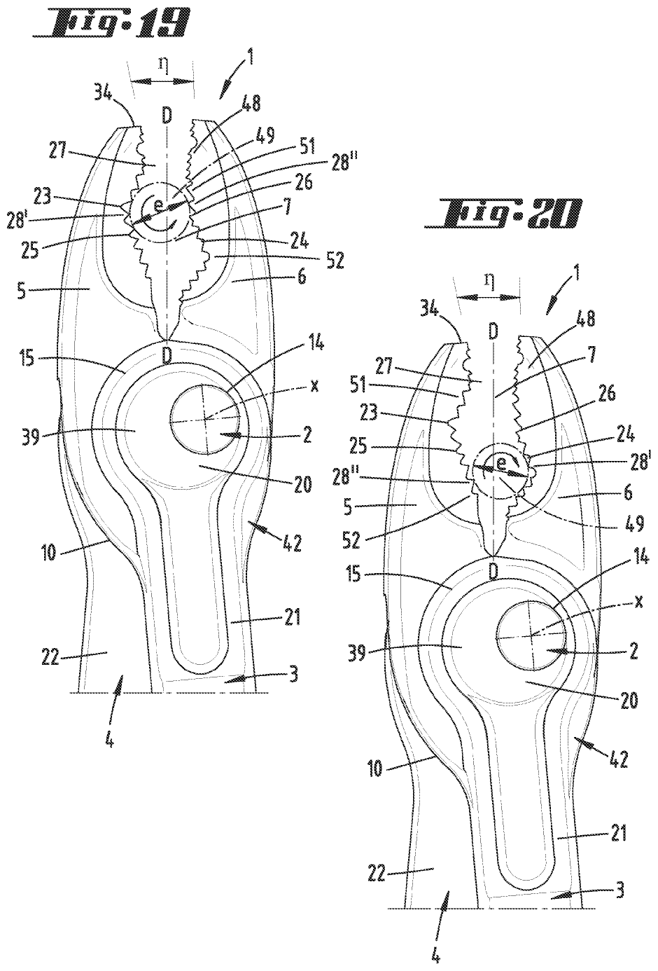

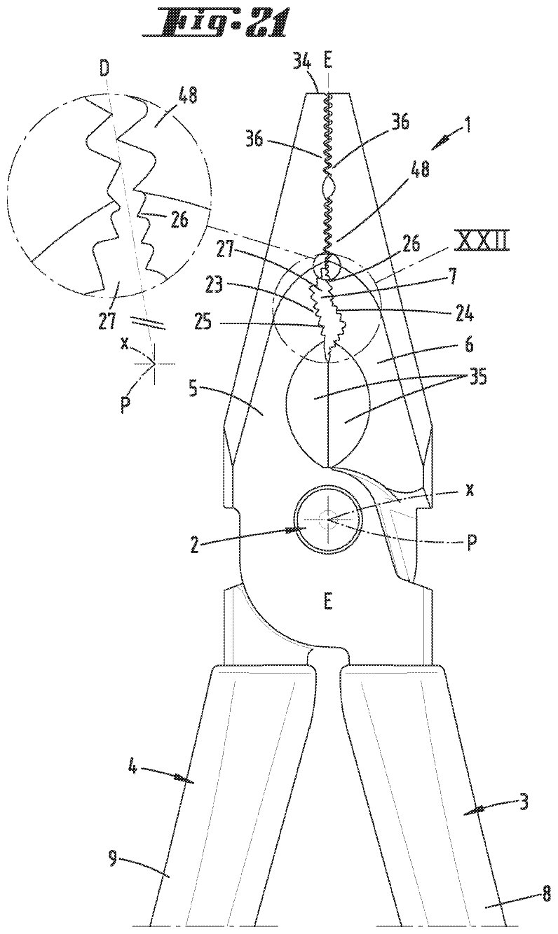

FIGS. 21 and 22 show such pliers 1 in the form of conventional universal pliers.

The pliers 1 have pliers arms 3 and 4 that cross one another in a joint bolt 2 with a joint bolt axis x. According to the exemplary embodiments shown, the pliers arm 3 is to be regarded as a stationary pliers arm and the pliers arm 4 is to be regarded as a movable pliers arm, which can be pivoted relative to the stationary pliers arm 3 about the joint bolt axis x in order to open and close a pliers mouth 7 formed between jaws 5 and 6 of the pliers arms 3 and 4.

The jaws 5 and 6 are formed on the pliers arms 3 and 4 on one side of the joint bolt 2 whereas the sections of the pliers arms 3 and 4 facing away from the jaws of 5 and 6 form gripping sections 8 and 9.

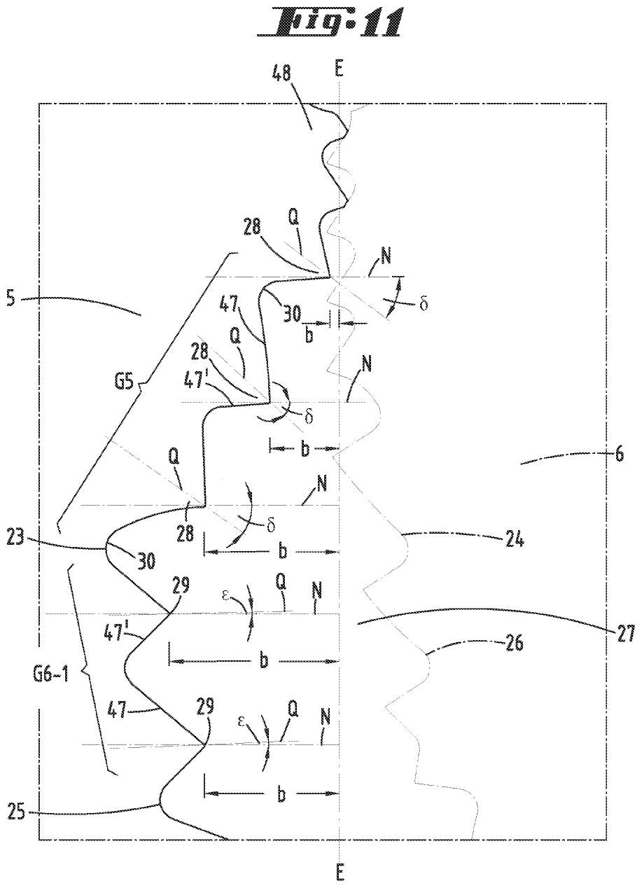

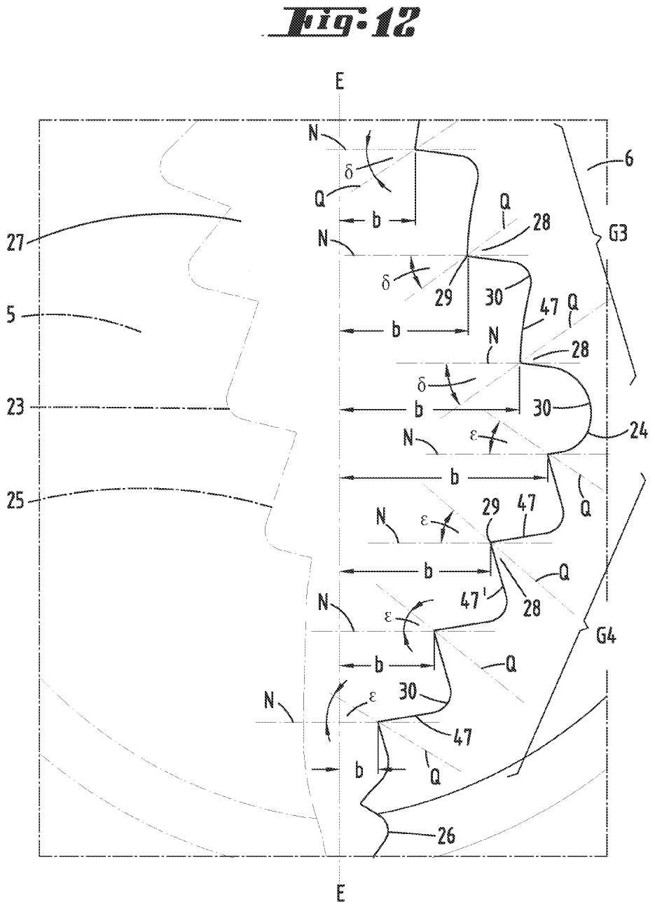

According to the first exemplary embodiment illustrated in FIGS. 1 to 13, the stationary pliers arm 3 may be designed in a fork-shaped manner in the intersection area with the movable pliers arm 4 in order to encompass the movable pliers arm 4, which penetrates the stationary pliers arm 3 in the region of a correspondingly formed slot opening 10, on both sides.

The joint bolt 2 is received in a bore-like receptacle 12 in a fork section 11 of the stationary pliers arm 3 and penetrates a longitudinal slot 13 in the intersection area of the movable pliers arm 4, as well as an additional bore-like opening 14, which is formed in the other fork section 15 of the stationary pliers arm 3 in axial extension of the bore-like receptacle 12.

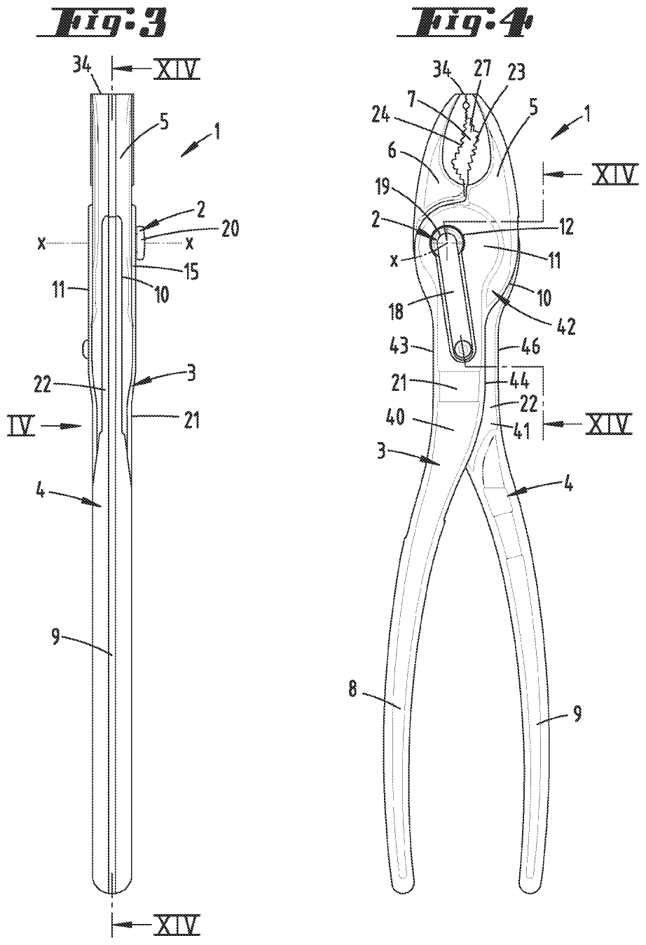

The longitudinal slot 13 has an extent S along a longitudinal center line 50 that, when the pliers 1 are closed, e.g. according to the illustration in FIG. 2, preferably extends transverse to the orientation of the pliers arms 3 and 4 on the gripping side and therefore preferably transverse to a longitudinal extent L of the pliers 1 as a whole.

The longitudinal slot 13 preferably can be realized with a toothing 16 along at least one longitudinal edge, preferably along both longitudinal edges, in order to cooperate with a counter toothing 17 formed on the outer wall of the joint bolt 2.

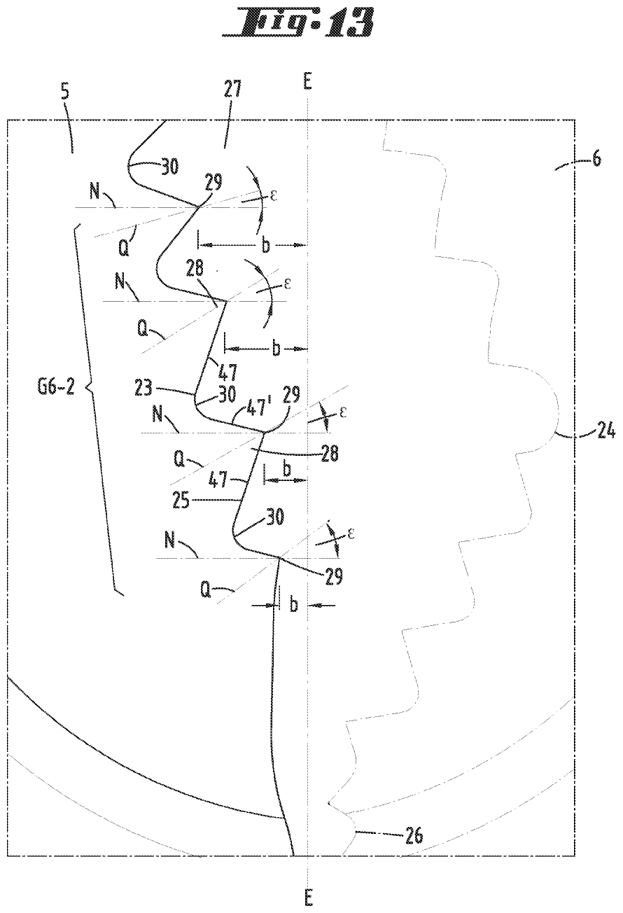

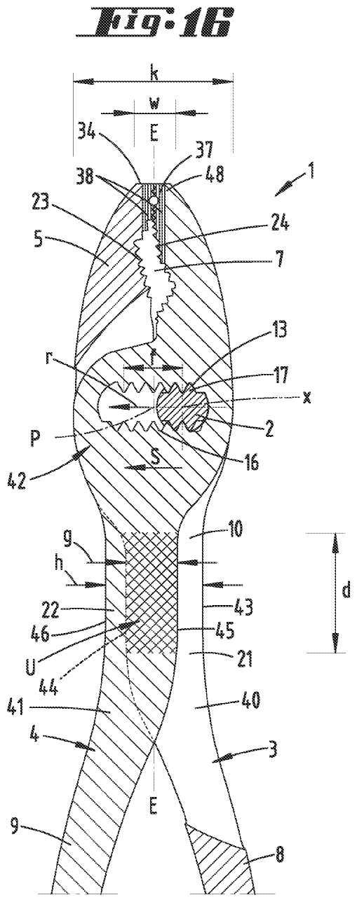

This counter toothing 17 extends from a joint bolt base 19, which lies in the receptacle 12 of the fork section 11, in the direction of the joint bolt axis x over approximately half the extent of the joint bolt 2 such that a toothing engagement is realized between the joint bolt 2 and the longitudinal slot 13 in a basic orientation of the joint bolt 2, for example, according to the illustrations in FIGS. 14 and 16.

The joint bolt 2 preferably is acted upon by a spring, for example a leaf spring 18, in this basic orientation. In this case, the leaf spring 18 preferably can be anchored in the region of the fork section 11 of the stationary pliers arm 3 and act upon the joint bolt base 19 with its free end in such a way that the joint bolt 2 is stressed in the direction of the toothing engagement in a stop-limited manner.

In this basic orientation, the joint bolt 2 furthermore protrudes beyond the outer edge of the additional opening 14 formed in the fork section 15, which outer opening edge points axially outward, such that a plate-like actuating projection 20 is formed.

The leaf spring 18 preferably is arranged in such a way that it extends from a supporting region formed on the associated end of the joint bolt, namely the joint bolt base 19, to the overlap region and is fastened on the stationary pliers arm in the overlap region.

A calotte-like depression 39 may be formed in the fork section 15 such that it surrounds the above-described opening 14 in the fork section 15. This depression 39 preferably serves as a thumb depression of sorts during the actuation of the joint bolt 2.

A depression center axis y extending parallel to the joint bolt axis x preferably is arranged eccentric to the joint bolt axis x, wherein it is furthermore preferred that a corresponding offset is realized in the adjustment direction r of the pliers mouth 7, which is defined by the orientation of the longitudinal slot 13. A corresponding degree of offset a may correspond to approximately 0.3-times to 0.8-times, furthermore to approximately 0.5-times, the bolt diameter (compare to FIG. 2).

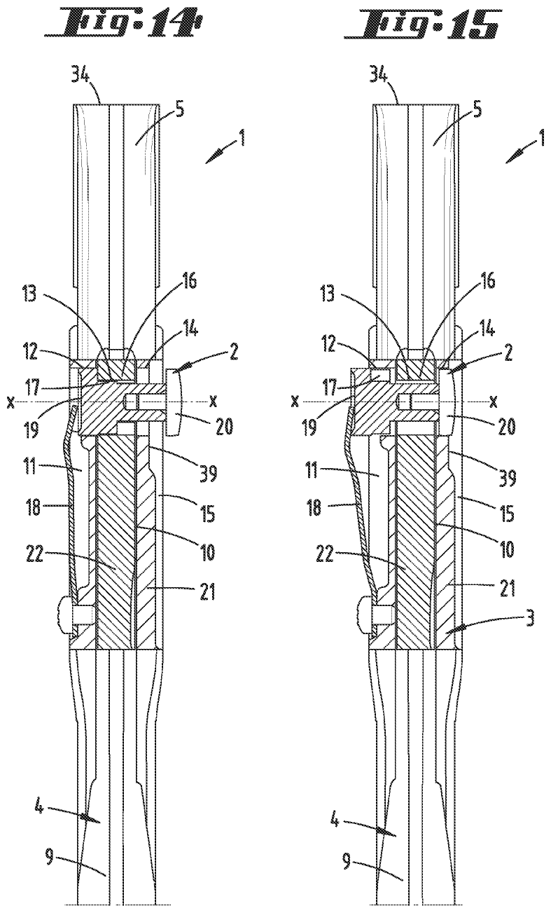

In order to change a mouth opening width w between the jaws 5 and 6, the joint bolt 2 initially needs to be displaced in the axial direction, optionally against the restoring force of the leaf spring 18, in such a way that the toothing engagement with the longitudinal slot 13 is released. To this end, the joint bolt 2 preferably can be subjected to a pressure load in the region of the actuating projection 20, e.g. as a result of a thumb actuation. The toothing engagement is released in the axially displaced position of the joint bolt 2 according to the illustration in FIG. 15 such that the movable pliers arm 4 can be linearly displaced relative to the stationary pliers arm 3 in the adjustment direction r.

In this displaced position of the joint bolt 2, its base 19 may be moved into a position, in which it is spaced apart from the associated surface of the fork section 11 in the direction of the joint bolt axis x. The joint bolt 2 accordingly protrudes from the receptacle 12 with the end facing away from the actuating projection 20 (compare to FIG. 15).

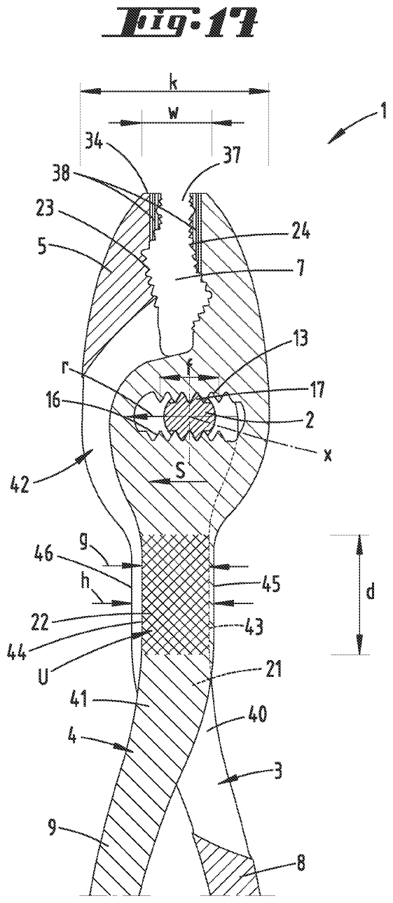

FIGS. 16 to 18 show the pliers 1 according to the first embodiment with differently adjusted mouth opening widths w, wherein FIG. 16 shows an example of the smallest mouth opening width w possible, FIG. 18 shows an example of the greatest mouth opening width w possible and FIG. 17 shows an intermediate position.

In the described first exemplary embodiment, pliers arm sections 21 and 22 with essentially equidirectional extent, particularly in the closed position of the pliers, e.g., according to FIG. 16, furthermore are formed between the crossing fork sections 11 and 15 and the gripping sections 8 and 9 viewed in the longitudinal extent L of the pliers 1. In the closed position of the pliers, these pliers arm sections 21 and 22 preferably extend essentially parallel to one another and furthermore preferably in parallel orientation to a longitudinal center plane E that centrally penetrates the pliers mouth 7. This longitudinal center plane E penetrates both pliers arms 3, 4 equally, particularly in the region of the pliers arm sections 21 and 22.

The pliers arm sections 21 and 22 are, viewed in the longitudinal extent of the pliers 1, essentially delimited by widenings formed in relation to these sections, namely by a respective offset region 40 and 41 on the gripping side and by the widening that forms the pliers head 42 with the longitudinal slot 13 and with the fork sections 11 and 15 on the opposite side (compare, in particular, to FIG. 16).

In the described closed position of the pliers mouth, the outer edges 43 and 44 delimiting the pliers arm section 21 preferably extend in perpendicular orientation to the longitudinal slot 13 or to the adjustment direction r, particularly parallel to one another and preferably also parallel to the other outer edges 45 and 46 of the pliers arm section 22.

In this case, the penetrating, movable pliers arm 4 is overlapped by the penetrated, stationary pliers arm 3 in an overlap region U (regions depicted with a hatching in FIGS. 16 to 18 in order to provide a better overview). The overlap essentially is formed in the region of the pliers arm sections 21 and 22.

An overall length d of the overlap region U viewed in the direction of the longitudinal extent L of the pliers 1 may correspond to approximately 2-times to 4-times the potential degree of adjustment f of the joint bolt 2 in the longitudinal slot 13 transverse to the longitudinal orientation of the pliers arm sections 21 and 22. The width g in the overlap region U between the outer edge 45 of the movable pliers arm 4 and the outer edge 44 of the stationary pliers arm 3 (compare to FIG. 16) or—depending on the mouth width adjustment—between the outer edge 43 of the stationary pliers arm 3 and the outer edge 46 of the movable pliers arm 4 (compare to FIGS. 17 and 18) may correspond to approximately 0.5-times to 2-times the potential degree of adjustment f of the joint bolt 2 in the longitudinal slot 13 transverse to the longitudinal orientation of the pliers arm sections 21 and 22. Furthermore, the width g of the overlap region may correspond to approximately 1.5-times to 4-times the corresponding length d.

In any case, the width g of the overlap region U may initially increase during an adjustment from a smaller mouth opening width w to a greater mouth opening width w, e.g. from the smallest mouth opening width w according to FIG. 16 into an intermediate position of the adjustable mouth opening according to FIG. 17, wherein an at least nearly complete overlap of the pliers arm sections 21 and 22 may be formed in this potential intermediate position. In contrast, the length d may be at least nearly identical in all mouth opening width positions of the pliers 1—referred to the respective closing position of the pliers mouth.

An increasing overlap width g accordingly results in a reduction of the width h of the pliers 1 in the region of the pliers arm sections 21 and 22. In this respect, a preferred smallest width h in the closed position of the pliers mouth may correspond to approximately 0.4-times to 0.6-times, furthermore to approximately 0.5-times, the length d. A potential greatest width h at only a partial overlap of the pliers arm sections 21 and 22 may correspond, for example, to approximately 0.6-times to 0.9-times, furthermore to approximately 0.75-times, the above-described length d of the pliers arm sections 21 and 22.

An altogether slender structural shape of the pliers 1 is achieved, particularly in the region of the pliers arm sections 21 and 22. The pliers arm sections 21 and 22 preferably recede behind the formation of the jaws 5 and 6 in any adjustment of the pliers mouth width. The width k of the pliers 1 viewed perpendicular to the longitudinal center plane E in the region of the jaws 5 and 6 corresponds—referred to the closing position of the pliers mouth—in any mouth opening width position to at least 1.3-times and up to approximately 2-times the equidirectionally viewed width h in the region of the pliers arm sections 21 and 22 in the overlap region U.

The jaws 5 and 6 have working surfaces 23 and 24, each of which is formed solely by a respective toothing 25 and 26 in the first exemplary embodiment illustrated in FIGS. 1 to 18. A mouth opening 27 of the pliers mouth 7 is also formed between these toothings 25 and 26 in a closed position of the pliers, e.g. according to FIG. 2.

Each toothing 25 and 26 is formed by teeth 28 that are pointed in the direction of the pliers mouth 7, wherein the tips 29 of these teeth and the valleys 30 formed between the teeth 28 essentially extend in the direction of the joint bolt axis x that forms a rotational axis.

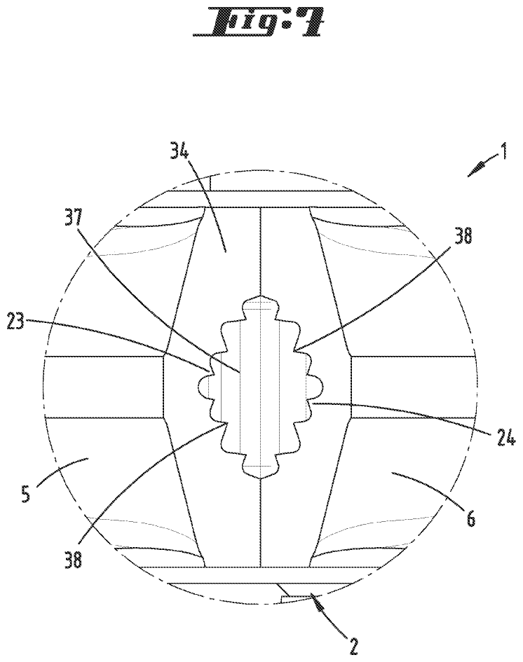

The pliers mouth 7 preferably also leaves a mouth opening 27, which extends transverse and longitudinal to the longitudinal center plane E and into which the teeth 28 of the toothing 25, 26 protrude, in a smallest closing position of the pliers. In a view, in which the rotational axis x is depicted in the form of a point and the longitudinal center plane E is depicted in the form of a line, the pliers mouth 7 initially is delimited by the working surfaces 23, 24 of the jaws 5, 6 on both sides of the longitudinal center plane E. According to the enlarged view in FIG. 5, the pliers mouth furthermore has a penetration plane D that may coincide, but does not have to coincide with the longitudinal center plane E. In the exemplary embodiment, the congruence with the longitudinal center plane E occurs when the pliers mouth is additionally closed after the penetration plane D has been generated as defined.

In the exemplary embodiment shown, the penetration plane D may extend about centrally referred to the working surfaces 23, 24 on the free end of the jaws 5, 6 in a pliers mouth 7 that is in the position according to the enlarged view in FIG. 5. However, the extent ultimately only depends on the rules that were already mentioned above and are once again explained below. In this respect, the penetration plane D may be formed in that it extends at a right angle to the longitudinal center line 50 of the longitudinal slot 13 in a maximally closed adjustment of the pliers mouth 7, wherein an intersection point P is formed between the penetration plane D and the longitudinal center line 50 (compare to FIG. 5).

In an embodiment according to FIGS. 21 and 22, the rotational axis x preferably extends in the penetration plane D as illustrated in the enlarged detail of FIG. 21 and also coincides with the longitudinal center plane E in the exemplary embodiment.

A greatest length of the penetration plane D mentioned in the context of this application refers to a dimension A from the end of the mouth opening 27 on the joint side up to the first contact of a tooth; in this respect, also see to the enlarged view in FIG. 5.

Furthermore, the orientation of the penetration plane D starting from the point P is chosen such that a simultaneous first contact of both working surfaces takes place on this penetration plane D at the free end 48 of both jaws 5 and 6 in the course of closing the pliers mouth 7, for example by the tooth tips in an end region of the jaws adjacent to the pliers mouth 7—viewed starting from the rotational axis x. This first contact preferably can take place prior to reaching a closed position of the pliers mouth. The enlarged detail in FIG. 5 shows this contact position—in contrast to the closed position illustrated otherwise in FIG. 5. This results in a linear contact of at least one respective tooth of each jaw 5 and 6 with the penetration plane D.

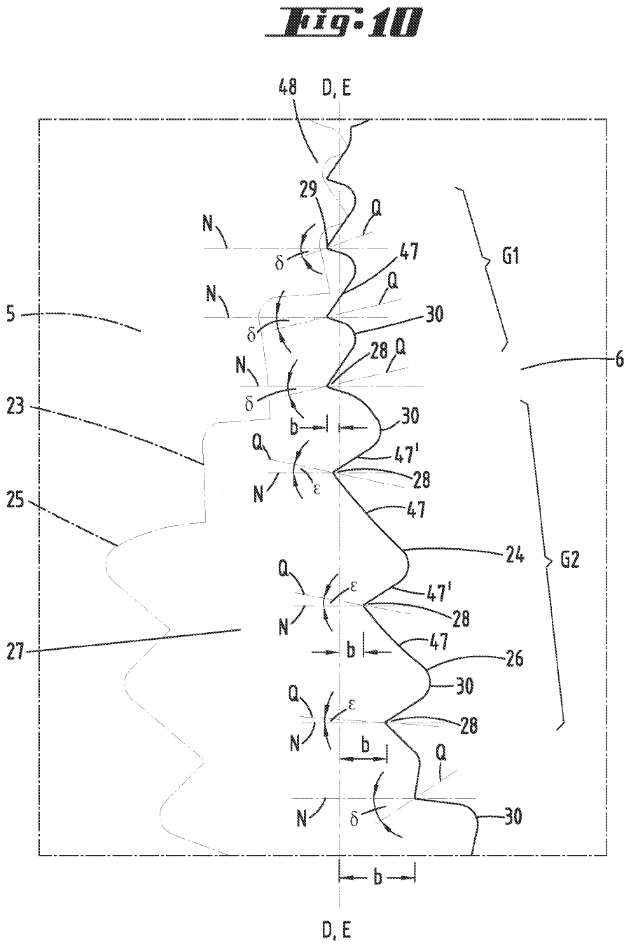

With respect to a side view of the pliers 1, for example, according to FIG. 9, the tooth tips 29 are flanked on both sides by tooth flanks 47 and 47′, which run into the tooth valleys 30 on the end facing away from the tooth tips 29. The tooth flanks 47 and 47′, which extend linearly in this view, include an angle with one another. In the highly enlarged views according to FIGS. 10 and 13, in which one respective jaw is merely illustrated with dot-dash lines in order to provide a better overview, angle bisectors Q are drawn centrally to the tooth flanks 47 and 47′ of a tooth 28, wherein said angle bisectors respectively include an acute angle δ or ε with a perpendicular N, which intersects the tooth tip 29 in the same point as the angle bisector Q and is oriented transverse to the penetration plane D, in the region, in which the angle bisector Q extends within the pliers mouth 7.

FIGS. 9, 11 and 13, in particular, show that two groups G5 and G6 of teeth 28 with different orientation of the respective acute angle δ or ε are formed on the jaw 5. In a view from a free end 48 of the jaw 5, which respectively faces away from the rotational axis or the joint bolt axis x, or from the corresponding working surface 23 toward the joint bolt axis x, a first group G5 of teeth 28, the acute angle δ of which is formed between the perpendicular N and the joint bolt axis x, is realized on this second working surface 23.

Starting from the tooth tip 29, the angle bisectors Q of the teeth 28 of this group G5 extend, facing away from the pliers mouth 7, at an ascending incline in the direction of the free end 48 of the jaw 5.

The acute angle δ of a tooth 28 in the group G5 may amount, for example, to approximately 20 to approximately 50 degrees, furthermore to approximately 25 to approximately 40 degrees.

The tooth tips 29 of this first group G5 of the jaw 5, which point into the pliers mouth 7, are with respect to the side view oriented in the direction of the joint bolt axis/rotational axis x within the pliers mouth 7. This results in a corresponding sweep of the teeth 28 in the direction of the joint bolt axis/rotational axis x.

The perpendicular distance b of the tooth tip 29 from the penetration plane D increases incrementally within the group G5 starting from the free end 48. According to the exemplary embodiment shown, the distance b may approximately double from tooth to tooth starting from the free end 48.

This group G5 is followed by the second group G6 of teeth 28, the acute angles ε of which are respectively formed between the perpendicular N and the free end 48 and the angle bisectors Q of which extend, facing away from the pliers mouth 7, at a descending incline from the tooth tips 29 in the direction of the joint bolt axis x.

This second group G6 preferably can be divided into two subgroups G6-1 and G6-2. In this case, the acute angles ε of the subgroup G6-1 following the first group G5 are chosen significantly smaller than the acute angles ε of the subgroup G6-2 following this subgroup G6-1 in the direction of the rotational axis x. Accordingly, the descending incline in the region of the subgroup G6-1 is shallower than in the subgroup G6-2.

For example, acute angles between approximately 0.5 (or less and optionally nearly 0 degrees) and approximately 10 degrees, furthermore between approximately 1 and approximately 5 degrees, may be realized with respect to the first subgroup G6-1 of the second group and acute angles ε between approximately 10 and approximately 45 degrees, furthermore between approximately 15 and approximately 40 degrees, may be realized with respect to the second subgroup G6-2. The angle ε of the second subgroup G6-2 accordingly may correspond to approximately 1.5-times to approximately 100-times, furthermore to approximately 3-times to approximately 50-times, the acute angle ε of the first subgroup G6-1.

Starting from the tooth 28 of the second group G6 or the first subgroup G6-1, which directly follows the first group G5, the perpendicular distance b of the teeth 28 from the penetration plane D may decrease incrementally in the direction toward the rotational axis x. In this case, the distance b of the first tooth 28 of the second group G6, which directly follows the first group G5, may be chosen, for example, 1.2-times to 1.7-times greater than the distance b of the tooth 28 of the first group G5, which directly follows the second group G6 in the direction of the free end 48.

The respective distance b may decrease from tooth to tooth in the direction of the last tooth 28 of the second group G6 facing the rotational axis x, namely to approximately 0.5-times to approximately 0.8-times the distance b of the tooth 28 of the same group G6, which lies directly adjacent in the direction of the free end 48.

With respect to the working surface 23 of the jaw 5, a nearly continuous increase of the distance b may initially be realized in the region of the group G5 from the free end 48 toward the rotational axis x, wherein this is followed by a preferably nearly continuous decrease of the distance b due to the transition to the second group G6.

The tooth tips 29 of the second group G6 of the jaw 5 are with respect to the side view oriented in the direction of the free end 48, wherein this results in a corresponding sweep of the teeth 28 in the direction of the pliers tip 34.

According to the exemplary embodiment shown, four groups G1 to G4 of teeth preferably are formed on the working surface 24 of the jaw 6 and arranged successively in a row, namely in the sequence G1, G2, G3, G4 in the longitudinal direction L of the working surface 24 starting from the free end 48 in the direction of the joint bolt axis/rotational axis x, wherein each group change involves a change in the orientation of the acute angles δ and ε or a change of the incline in the direction of the free end or the rotational axis x (compare, in particular, to FIGS. 9, 10 and 12).

In this case, the acute angles δ of the groups G1 and G3 may respectively be formed between the perpendicular N and the rotational axis x whereas these acute angles ε are formed between the perpendicular N and the free end 48 in the groups G2 and G4. Accordingly, the angle bisectors Q are inclined, facing away from the pliers mouth 7, toward the free end in groups G1 and G3 and toward the rotational axis x in groups G2 and G4.

The acute angle δ of a tooth 28 in the group G1 may amount, for example, to approximately 5 to approximately 30 degrees, furthermore to approximately 10 to approximately 20 degrees. The acute angles in the group G3 may be at least partially chosen greater than in the group G1. In this respect, an acute angle δ in the group G3 may be chosen, for example, between approximately 20 and approximately 60 degrees, furthermore between approximately 30 and approximately 45 degrees.

The acute angle ε of a tooth 28 in the group G2 may with respect to its value lie in approximately the same range as that described with reference to the acute angle δ of the first group G1, but this acute angle ε is formed on the side of the perpendicular N lying opposite of the angle δ. The acute angles in the group G4 may be at least partially chosen greater than in the group G2. A value range of the acute angle ε of the group 4 preferably can correspond to the value range described with reference to the acute angle δ of group G3.

Furthermore, two areas C1 and C2 may be formed, wherein said areas are respectively composed of a group with acute angles δ and an adjacent group with acute angles ε, wherein the acute angles δ and ε of these two groups have identical or nearly identical value ranges. In the described exemplary embodiment, a first area C1 is composed of the groups G1 and G2 and a second area C2 is composed of the groups G3 and G4.

Furthermore, the distances b in the area C2, i.e. in the region of the groups G3 and G4, obviously are chosen significantly greater than in the first area C1.

The distances b between the tooth tips 29 and the penetration plane D are formed in the free space of the pliers mouth 7 on the working surface 23 of the other jaw 5 whereas negative distances b may in contrast be formed in the region of the opposite working surface 24, particularly in the region of the first group G1, due to an extent of the respective tooth 28 beyond the penetration plane D. This accordingly results in a distance b, which is measured along the perpendicular N within the tooth 28 starting from the tooth tip 28 in the direction of the tooth valley 30.

In this case, the distance dimension corresponds to a protruding dimension of the tooth 28 beyond the penetration plane D, wherein such a free protrusion beyond the penetration plane D can optionally only be reached at the smallest mouth opening width in the closed position of the pliers illustrated in FIG. 9.

Such a protruding dimension (distance b) preferably lies in the low 1/10 mm range, e.g. in a range up to 0.5 mm.

The distance b of the teeth 28 of the groups G2 and G3 and optionally of the tooth 28 of the fourth group G4, which directly follows the third group G3, increases incrementally in the direction of the rotational axis x viewed up to the transition from the group G3 to the group G4, particularly starting from the transition of the first group G1 to the second group G2. In this case, the value of the increase from tooth to tooth within the second group G2 may be greater than the increase from tooth to tooth within the third group G3.

For example, an increase of the respective distance b from tooth to tooth in the region of the second group G2 may amount to approximately 1.5-times to approximately 2-times the distance b of the tooth 28 of the same group G2, which lies directly adjacent in the direction of the free end 48. The distance b from tooth to tooth in the third group G3 may increase, for example, by approximately 1.2-times to approximately 1.5-times the distance b of the tooth 28 of the same group G3, which lies directly adjacent in the direction of the free end 48.

It is preferred that an incremental decrease of the distance b essentially takes place only in the region of the fourth group G4. In this case, the respective distance b may decrease from tooth to tooth—viewed in the direction of the rotational axis x starting from the transition from the third group G3 to the fourth group G4—by approximately 1.5-times to approximately 2.5-times the distance b of the tooth 28 of the same group G4, which lies directly adjacent in the direction of the free end 48.

The tooth tips 29 of the first and the third group G1 and G3 of the jaw 6 are with respect to the side view oriented in the direction of the joint bolt axis x, wherein this results in a corresponding sweep of the teeth 28 in the direction of the gripping sections 3 and 4. In contrast, the tooth tips 29 of the second and the fourth group G2 and G4 are with respect to the side view oriented in the direction of the free end 48. This accordingly results in a sweep of the teeth 28 in the direction of the pliers tip 34.

Groups of teeth 28 of both working surfaces 23 and 24 or of both jaws 5 and 6 with a certain angular orientation (angle δ or ε) are at least partially arranged opposite of one another referred to the longitudinal center plane E or the penetration plane D, respectively. With respect to a perpendicular projection of the groups along the perpendicular N on the respective longitudinal center plane E or penetration plane D, a partial overlap preferably is formed between the group G1 of the first working surface 24 and the group G5 of the second working surface 23 whereas the group G6 of the second working surface 23 overlaps with the equidirectionally oriented teeth 28 of the groups G2 and G4 of the first working surface 24, as well as the third group G3 having oppositely oriented tooth tips 29. An offset arrangement of the tooth tips 29 of both working surfaces 23 and 24 along the penetration plane D is furthermore preferred, particularly in the closed position of the pliers mouth illustrated, for example, in FIG. 9. In the preferred projection perpendicular to the longitudinal center plane E, a tooth valley 30 of one working surface essentially lies opposite of a tooth tip 29 of the other working surface.

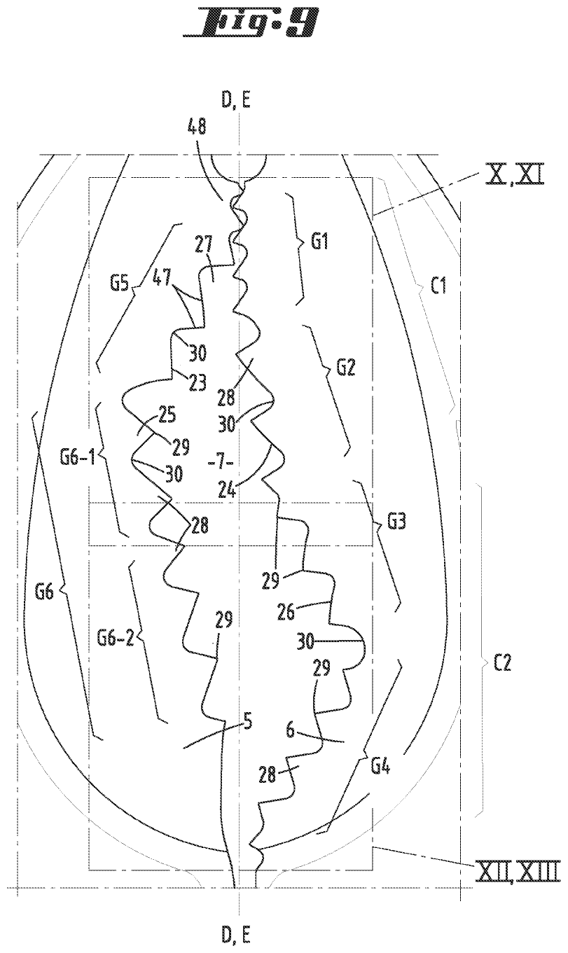

With respect to a side view of the pliers 1 according to FIG. 8 or a cross section, for example, according to FIG. 16, in which side view or in which cross section the joint bolt axis x is depicted in the form of a point, a polyline Z and Z′ connecting the tooth tips 29 of each toothing 25 and 26 may form linear segments T between two tooth tips 29 that are essentially arranged successively in the longitudinal extent L.

In this case, a respective wave-like polyline Z or Z′ with—viewed outward starting from the mouth opening 27—a wave crest 31 and a wave trough 32 is altogether formed, wherein it is preferred that a wave trough 32 of one polyline Z′, Z essentially lies opposite of a wave crest 31 of the other polyline Z, Z′, e.g. mirrored to the longitudinal center plane E or penetration plane D.

A transition 33 is formed in the transition from a wave crest 31 to a wave trough 32 of a respective polyline Z or z′.

In any case, two adjacent segments T of the respective polyline Z or Z′ are formed in the region of a wave crest 31, wherein said segments include, facing the pliers mouth 7, an angle α of 170 degrees or less with one another, for example an angle α of approximately 150 degrees or also 165 degrees with respect to the polyline Z and an angle α of approximately 130 degrees or 170 degrees with respect to the polyline Z′.

Included angles β of 170 degrees or more may be formed in the region of the wave troughs 32 between two segments T that lie adjacent to one another in the direction of the respective polyline Z or Z′, wherein said angles amount to approximately 180 degrees with respect to the polyline Z and to approximately 185 degrees with respect to the polyline Z′ in the exemplary embodiment shown.

Two segments T that, pointing in the direction of the pliers mouth 7, preferably include an angle γ of more than 190 degrees with one another preferably can be formed in the region of the transition 33 in each polyline Z or Z′, wherein an angle γ with respect to the polyline Z preferably amounts, for example, to approximately 195 degrees and an angle γ with respect to the polyline Z′ preferably amounts, for example, to approximately 200 degrees.

An altogether rhombic mouth opening area M, which is delimited by the polylines Z and Z′, may be formed, for example, at the smallest mouth opening width w in the closed position of the pliers mouth, e.g. according to the illustration in FIG. 8.

Furthermore, the tooth flanks 47 and 47′ of the teeth 28 preferably are angularly oriented relative to one another in such a way that a rearward sweep in the direction of the joint bolt axis x is respectively formed in the region of the wave crests 31 of both working surfaces 23 and 24 and a tendential sweep in the direction of the pliers tip 34 is formed in the region of the wave troughs 32. An essentially neutral orientation of the teeth 28 is realized in the region of the transitions 33.

The orientation of the tooth tips 29 may furthermore be defined by different lengths of the tooth flanks 47 and 47′ of a tooth. For example, FIGS. 10 to 13 show that, in a tendential orientation of the tooth tip 29 in the direction of the free end 48, the longer tooth flank 47 is formed on the side of the tooth 28 that faces the rotational axis x and therefore faces away from the free end 48. In a tendential orientation of the tooth tip 29 in the direction of the rotational axis x, in contrast, the shorter tooth flank 47′ is formed on the side facing away from the free end 48.

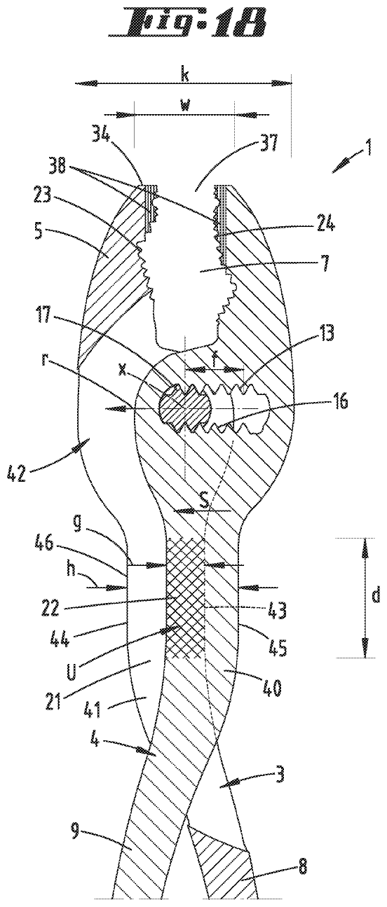

This advantageously allows a partition of the pliers mouth 7, particularly when the pliers 1 are used for grasping a body to be rotated by means of the pliers mouth 7. For example, the front teeth 28 facing the pliers tip 34 in a front region 51 preferably serve for exerting a counterclockwise rotation upon a body in the region of the wave crest 31 of the working surface 22 and the wave trough 32 of the working surface 24, e.g. in order to loosen a screw connection (compare to FIG. 19), and the teeth 28 facing the rotational axis or the joint bolt axis x in a rear region 52 serve for exerting a clockwise rotation in the region of the wave trough 32 of the working surface 23 and the wave crest 31 of the working surface 24, e.g. in order to tighten a screw connection (compare to FIG. 20).

A workpiece, for example, in the form of a round bolt 49 illustrated in FIGS. 19 and 20 can be grasped by the teeth 28 of the working surfaces 23 and 24 in a front region 51 or a rear region 52, wherein the round bolt 49 is respectively grasped at least twice by at least one tooth 28′ and 28″ of each working surface 23 and 24. This twofold grasping takes place at least on the diameter e of the round bolt 49 shown, wherein said diameter e preferably requires an opening angle η of the pliers mouth of approximately 10 degrees. The diameter e of the round bolt 48 may, while maintaining the opening angle η of, for example, approximately 10 degrees, be chosen smaller when grasping takes place in the front region 51 than when grasping takes place in the rear region 52.

The round bolt 49 preferably is grasped in the front region 51 by a tooth 28″ of the first group G1 of the first working surface 24, which is oriented at an incline in the direction of the free end 48, and optionally by two teeth 28, but in any case one tooth 28′, of the second group G6 of the second working surface 23, wherein, in a potential contact with two teeth 28 of the second working surface 23, these teeth belong to different groups G5 and G6 that follow one another in the longitudinal extent of the pliers mouth 7. Accordingly, grasping in this region preferably takes place in the region of a wave trough 32 of the polyline Z.

When the round bolt 49 is grasped in the rear region 52 according to FIG. 20, grasping in the region of the second working surface 23 takes place by a tooth 28″ of the second group G6, which is oriented in the direction of the free end 48, and at least one tooth 28′ of the second group G2 of the first working surface 24, which is oriented in the direction of the rotational axis x. Additional grasping optionally may take place by a tooth 28′ in the region of the group G3 of the first working surface 24.

The arrangement and design of the teeth 28 along the respective polylines Z and Z′ allows the use of the pliers 1 with the proposed pliers mouth 7 over a comparatively large diameter range of the workpiece to be grasped, e.g. over a range of approximately 1.5 to 4 millimeters and more, furthermore up to 16 or 20 mm or more.

According to the illustrations in FIGS. 21 and 22, such a design of the pliers mouth 7 can also be realized in so-called universal pliers, e.g. in order to design the pliers mouth 7 in the form of a burner hole. Viewed in the longitudinal extent L of the pliers 1, cutting edges 35 may also be provided in front of the pliers mouth 7 in the direction of the rotational axis x and the working surfaces 23 and 24 furthermore may form grasping surfaces 36 adjacent to the pliers mouth 7 in the direction of the pliers tip 34.

As an alternative to the altogether approximately rhombic arrangement of the polylines Z and Z′ of both working surfaces 23 and 24, the working surfaces 23 and 24 may have two opposite rows with groups of teeth 28, the polylines Z and Z′ of which or an enveloping surface connecting the tooth tips 29 may in the above-described view extend linearly over the entire extent of the respective toothing 16 (compare to FIG. 23), optionally with parallel orientation to the penetration plane D. The linearly extending polylines Z, Z′ of both working surfaces 23, 24 may also extend divergent to one another and include, for example, an acute angle of 10 degrees or 20 degrees with one another.

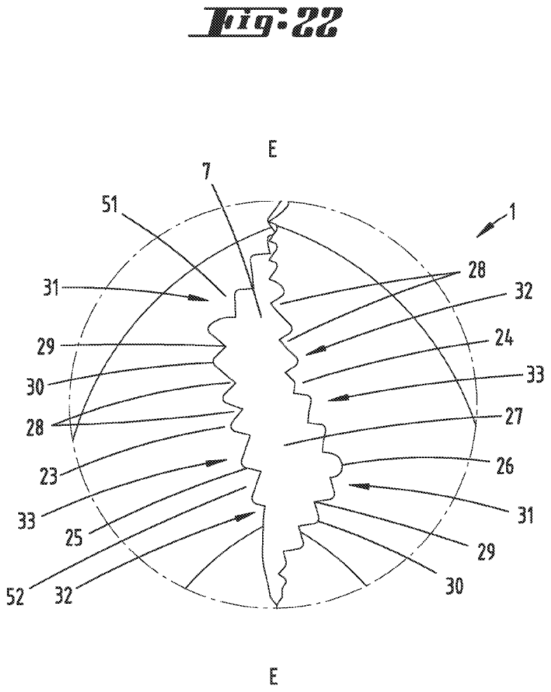

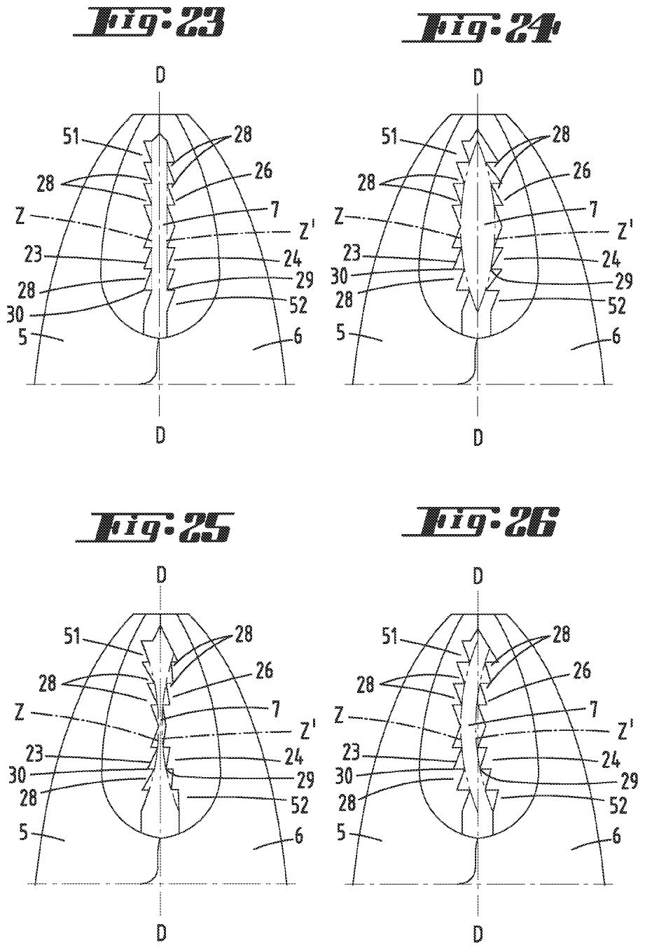

As another alternative in this respect, both polylines Z and Z′ or the enveloping surfaces also may—respectively viewed outward starting from the penetration plane D—have a convex orientation (compare to FIG. 24), wherein both polylines Z and Z′ or the enveloping surfaces alternatively may, once again viewed outward starting from the penetration plane, have a concave orientation (compare to FIG. 25). It would also be possible that, viewed outward starting from the penetration plane D, one polyline Z or Z′ or one enveloping surface extends in a concavely curved manner and the other polyline Z′ or Z or the other enveloping surface extends in a convexly curved manner (compare to FIG. 26).

With respect to the penetration plane D, a tooth 28 of the respective working surface 23 or 24, particularly its tooth tip 29, essentially may lie opposite of a tooth valley 30 that is formed between two teeth 28 of the other working surface 24 or 23 in the extending direction of the assigned polyline Z or Z′. The tooth design, particularly the extent of the tooth flanks 47 and 47′, may with respect to the working surfaces 23 and 24 be realized differently in corresponding adaptation to the extent of the polylines Z and Z′, particularly in instances in which both polylines Z and Z′ extend, for example, in a similarly concave or similarly convex manner (compare to FIGS. 24 and 25).

Each working surface 23 and 24 is provided with a toothing 16 regardless of the extent of the polylines Z and Z′ or the enveloping surfaces, wherein the pointed teeth 28 of a group of the second working surface 23, which is assigned to the front region 51, have an orientation in the direction of the rotational axis x and the teeth 28 of another group of the same working surface 23 in the rear region 52 have an orientation in the direction of the free end 48. The abaxial group of the first working surface 24 in the front region 51 preferably has teeth 28 that extend at an incline in the direction of the free end 48. In contrast, another group of the same working surface 24, which is assigned to the rear region 52, preferably is provided with teeth 28 that are inclined in the direction of the rotational axis x.

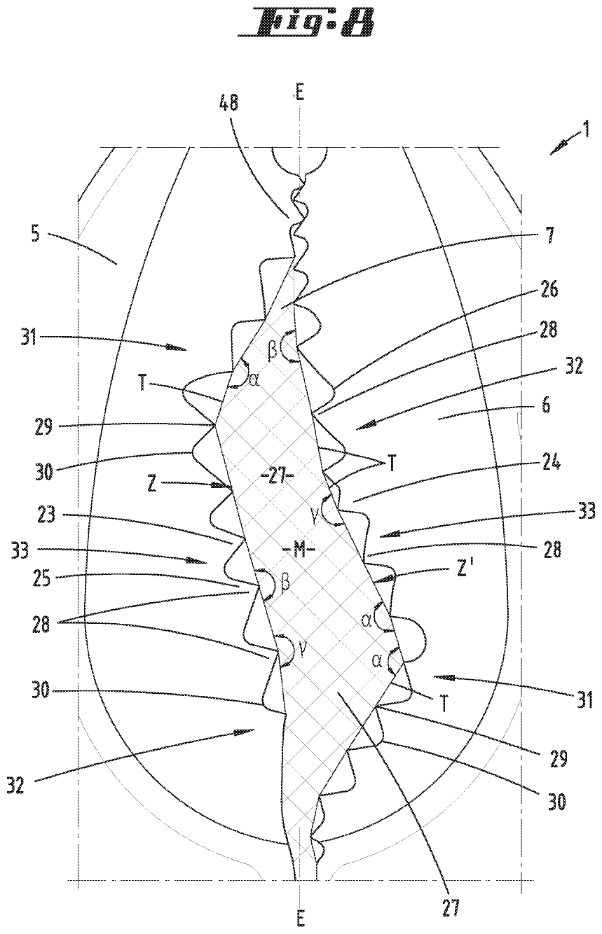

In pliers 1 according to the first exemplary embodiment, but also in pliers 1 that are realized in the form of universal pliers according to the second exemplary embodiment, the working surfaces 23 and 24 furthermore have depressions extending in the direction of the pliers tip 34 such that an opening 37 remains on the side of the pliers tip, particularly when the pliers 1 are closed, in a front view of the pliers mouth 7 according to the illustration in FIG. 6. In this way, an opening 37 with a peripheral toothing 38 can be formed by depressions that preferably extend linearly in the longitudinal extent L. The thusly designed pliers 1 accordingly are also suitable for encompassing a body on the side of the tip, e.g. in order to turn said body.

The groups of teeth with different orientation illustrated in FIGS. 23 to 26 may be respectively supplemented with one or more additional groups in the respective working surface. With respect to the orientation, the additional groups are realized in such a way that they are once again oriented opposite to the adjacent group.

The preceding explanations serve for elucidating all inventions that are included in this application and respectively enhance the prior art independently with at least the following combinations of characteristics, wherein two, multiple or all of these combinations of characteristics may also be combined with one another, namely:

Pliers, which are characterized in that the toothing 16 can be overrun by depressing the joint bolt 2 in order to adjust a mouth opening width w, wherein the penetrating pliers arm 4 has an elongate overlap region U, in which the penetrating pliers arm 4 is overlapped on both sides by the penetrated pliers arm 3, and wherein the overlap region U essentially extends at a right angle to an adjustment direction r of the joint bolt 2 in the longitudinal slot 16, with a width g that corresponds to 0.5-times the maximum degree of adjustment f or more and with a length d that corresponds to 2-times the maximum degree of adjustment f or more.

Pliers, which are characterized in that a greater surface overlap of the pliers arm sections 21, 22 on the gripping side is initially formed in any case in the course of the adjustment from a smaller to a greater mouth opening width w.

Pliers, which are characterized in that a width h of the pliers 1 in the region of the overlap is initially reduced during an adjustment from a closed position of the pliers 1 to a greater mouth opening width (w).

Pliers, which are characterized in that the stationary pliers arm 3 has a depression 9 that is designed for the pressure actuation of the joint bolt 2, wherein a joint bolt axis x is arranged eccentrically to a geometric center axis y of the depression.

Pliers, which are characterized in that the joint bolt axis x is offset relative to the center axis y of the depression in the adjustment direction r of the pliers mouth 7.

Pliers, which are characterized in that the jaws 5, 6 have working surfaces 23, 24 that are provided with a toothing 25 and 26.

Pliers, which are characterized in that the working surfaces 23, 24 deepen, with respect to a longitudinal extent L of the pliers mouth 7, toward the pliers tip 34 such that an opening 37 remains in a front view of the pliers mouth 7 when the pliers 1 are closed.

Pliers, which are characterized in that both working surfaces 23, 24 respectively have teeth 29 in their extent from the free end 48 of the jaws 5, 6 to the rotational axis x, wherein said teeth have tooth tips 29 that are oriented in the direction of the rotational axis x and are followed by additional teeth 28 in the same working surface 23, 24, wherein the tooth tips 29 of these additional teeth are oriented toward the free end 48 of the jaws 5, 6, or vice versa, and wherein oppositely oriented groups G1, G2, G3, G4, G5 and G6 of teeth 28 furthermore are respectively formed opposite of one another on the first and the second working surface 23, 24.

Pliers, which are characterized in that, viewed from a free end of the working surfaces 23, 24 of the pliers mouth 7 toward the rotational axis x, a first group G1 of teeth 28 is initially formed on a first working surface 24 of the pliers mouth 7, wherein the respective angle bisector Q of the teeth 28 of this first group extends at an incline starting from the tooth tip 29 and, facing away from the pliers mouth 7, toward the free end of the jaw 6, wherein this first group of teeth is followed by a second group G2 of teeth 28, in which the respective angle bisector Q extends at an incline toward the end of the pliers mouth 7 on the joint side, and wherein this second group of teeth is followed by a third group G3 of teeth 28, in which the respective angle bisector Q once again extends at an incline toward the free end of the jaw 6.

Pliers, which are characterized in that, viewed from the free end 50 of the working surfaces 23 and 24 of the pliers mouth 7 toward the rotational axis x, a first group G1 of teeth 28 is initially formed on a first working surface 24 of the pliers mouth 7, wherein the acute angle δ of this first group of teeth is respectively formed between the perpendicular N and the rotational axis x, wherein this first group of teeth is followed by a second group G2 of teeth 28, in which the acute angle ε is respectively formed between the perpendicular N and the free end 50 of the working surfaces 23 and 24 of the pliers mouth 7, and wherein this second group of teeth is followed by a third group G3 of teeth 28, the acute angles δ of which are once again formed between the perpendicular N and the rotational axis x.

Pliers, which are characterized in that a fourth group G4 of teeth 28 follows the third group G3 of teeth 28, wherein the respective angle bisector Q of the teeth 28 of the fourth group extends at an incline toward the end of the pliers mouth 7 on the joint side.

Pliers, which are characterized in that a fourth group G4 of teeth 28 follows the third group G3 of teeth 28, wherein the acute angle ε of the teeth of the fourth group is formed between the perpendicular N and the free end 50 of the working surfaces 23 and 24 of the pliers mouth 7.

Pliers, which are characterized in that groups G1, G2, G3, G4, G5 and G6 of teeth 28 with a certain angular orientation respectively lie opposite of one another referred to the penetration plane D.

Pliers, which are characterized in that the tooth tips 29 are with respect to the opposed position arranged offset to one another through the longitudinal center plane E referred to the perpendicular N.

Pliers, which are characterized in that the second working surface 23 of the pliers mouth 7 is provided with a first group G5 of teeth 28, in which the respective angle bisector Q of the teeth 28 extends at an incline starting from the tooth tip 29 and, facing away from the pliers mouth 7, toward the free end of the jaw 5, wherein said first group is followed by a second group G6 of teeth 28, in which the respective angle bisector Q extends at an incline toward the end of the pliers mouth 7 on the joint side, and in that the second group G6 of teeth 28 has two subgroups G6-1 and G6-2 of teeth 28, wherein the angle bisector Q of a first subgroup G6-1 has a smaller incline and the angle bisector Q of a second subgroup G6-2 has a greater incline.

Pliers, which are characterized in that the second working surface 23 of the pliers mouth 7 is provided with a first group G5 of teeth 28, in which the acute angle δ is respectively formed between the perpendicular N and the rotational axis x, and with a second group G6 of teeth 28, in which the acute angle ε is respectively formed between the perpendicular N and the free end 50 of the working surfaces 23 and 24 of the pliers mouth 7, and in that the second group G6 of teeth 28 has two subgroups G6-1 and G6-2 of teeth 28, wherein a first subgroup G6-1 has smaller acute angles ε and a second subgroup G6-2 has greater acute angles ε.

Pliers, which are characterized in that a round bolt 49 can be grasped by one or more oppositely arranged and oppositely oriented teeth 28 of the first and the second working surface 23, 24 in a front region 51 facing the free end 48 of the jaws 5, 6, as well as in a rear region 52 of the pliers mouth 7 facing the rotational axis x, wherein teeth 28 of different groups G1, G2, G3, G4, G5 and G6 of teeth 28 are respectively engaged with the round bolt 49 in the front and the rear region, wherein the round bolt can be grasped in the rear region by two teeth 28, which are respectively assigned to one of the opposite working surfaces 23, 24 and the tooth tips 29 of which extend in opposite directions, and wherein the round bolt likewise can be grasped in the front region 51 by two teeth 28, which are respectively assigned to one of the opposite working surfaces 23, 24 and the tooth tips 29 of which extend in opposite directions.

Pliers, which are characterized in that twofold grasping of the round bolt 49 is in any case possible if the round bolt 49 has a diameter e that requires a pliers mouth opening of approximately 10 degrees for the aforementioned grasping of the round bolt 49 in the front region 51 or in the rear region 52.

Pliers, which are characterized in that the orientation of the tooth tips 29 is defined by a different length of tooth flanks 47, 47′ of the respective tooth 28, wherein the longer tooth flank 47 is formed on the side of the tooth tip 29 facing away from the rotational axis x if the tooth tip is oriented in the direction of the rotational axis x and the longer tooth flank 47 is formed on the side of the tooth tip 29 facing away from the free end 48 of the jaws 5, 6 if the tooth tip 29 is oriented toward the free end 48 of the jaws 5, 6.

Pliers, which are characterized in that each polyline Z, Z′ has in any case two adjacent segments T that, pointing toward the pliers mouth 7, include an angle α of 170 degrees or less to, for example, 100 degrees with one another, in that segments T of the other polyline Z′, Z lie opposite of these segments T and, pointing toward the pliers mouth 7, include an angle β of 170 degrees or more to, for example, 190 degrees with one another, and in that each polyline Z, Z′ contains two segments T that, viewed in the same direction, include an angle γ of 190 degrees or more with one another.

All disclosed characteristics are essential to the invention (individually, but also in combination with one another). The disclosure of the associated/attached priority documents (copy of the priority application) is hereby fully incorporated into the disclosure content of this application, namely also for the purpose of integrating characteristics of these documents into claims of the present application. The characteristics of the dependent claims also characterize independent inventive enhancements of the prior art without the characteristics of a claim to which they refer, particularly for submitting divisional applications on the basis of these claims. The invention specified in each claim may additionally comprise one or more of the characteristics that were disclosed in the preceding description and, in particular, are identified by reference symbols and/or included in the list of reference symbols. The invention also concerns design variations, in which individual characteristics cited in the preceding description are not realized, particularly as far as they are obviously dispensable for the respective intended use or can be replaced with other, identically acting technical means.

### LIST OF REFERENCE SYMBOLS

1 Pliers
2 Joint bolt
3 Pliers arm
4 Pliers arm
5 Jaw
6 Jaw
7 Pliers mouth
8 Gripping section
9 Gripping section
10 Slot opening
11 Fork section
12 Receptacle
13 Longitudinal slot
14 Opening
15 Fork section
16 Toothing
17 Counter toothing
18 Leaf spring
19 Joint bolt base
20 Actuating projection
21 Pliers arm section
22 Pliers arm section
23 Working surface
24 Working surface
25 Toothing
26 Toothing
27 Mouth opening
28 Tooth
28′ Tooth
28″ Tooth
29 Tooth tip
30 Tooth valley
31 Wave crest
32 Wave trough
33 Transition
34 Pliers tip
35 Cutting edge
36 Grasping surface
37 Opening
38 Toothing
39 Depression
40 Offset region
41 Offset region
42 Pliers head
43 Outer edge
44 Outer edge
45 Outer edge
46 Outer edge
47 Tooth flank
47′ Tooth flank
48 Free end
49 Round bolt
50 Longitudinal center line
51 Front region
52 Rear region
a Degree of offset
b Distance
d Length
e Diameter
f Degree of adjustment
g Width
h Width
k Width
r Adjustment direction
W Mouth opening width
X Joint bolt axis
Y Center axis of depression
A Dimension
C1 Area
C2 Area
D Penetration plane
E Longitudinal center plane
G1 Group
G2 Group
G3 Group
G4 Group
G5 Group
G6 Group
G6-1 Subgroup
G6-2 Subgroup
L Longitudinal extent
M Mouth opening area
N Perpendicular
P Point
Q Angle bisector
S Extent
T Segment
U Overlap region
Z Polyline
Z′ Polyline
α Angle
β Angle
γ Angle
δ Angle
ε Angle
η Angle

1: Pliers (1) comprising two pliers arms (3, 4), which cross one another in a joint bolt (2) having a joint bolt axis (x) and of which one pliers arm (4) is regarded as movable and the other pliers arm (3) as stationary, wherein gripping sections (8, 9) are formed on one side of the joint bolt (2) and jaws (5, 6), which cooperate as a mouth (7) of the pliers, are provided on the other side of the joint bolt (2), wherein the movable pliers arm (4) furthermore has a longitudinal slot (13) with a toothing (16) and the joint bolt (2) located in a receptacle (12) is movable out of a toothing engagement, wherein the movable pliers arm (4) penetrates the stationary pliers arm (3), and wherein the longitudinal slot (13) furthermore has an extent (S) that, with the pliers (1) closed, extends transverse to an orientation of the pliers arms (3, 4) on the gripping side, wherein the toothing (16) is configured to be overrun by depressing the joint bolt (2) in order to adjust a mouth opening width (w), wherein the movable pliers arm (4) has an elongate overlap region (U), in which the movable pliers arm (4) is overlapped on both sides by the stationary pliers arm (3), and wherein the overlap region (U) extends at a substantially right angle to an adjustment direction (r) of the joint bolt (2) in the longitudinal slot (16), with a width (g) that corresponds to 0.5-times a maximum degree of adjustment (f) or more and with a length (d) that corresponds to 2-times the maximum degree of adjustment (f) or more.

2: The pliers according to claim 1, wherein a greater surface overlap of pliers arm sections (21, 22) on the gripping side is initially formed in the course of adjustment from a smaller to a greater mouth opening width (w).

3: The pliers according to claim 1, wherein a width (h) of the pliers (1) in the the overlap region is initially reduced during an adjustment from a closed position of the pliers (1) to a greater mouth opening width (w).

4: The pliers according to claim 1, wherein the stationary pliers arm (3) has a depression (39) that is designed for pressure actuation of the joint bolt (2), wherein a joint bolt axis (x) is arranged eccentrically to a geometric center axis (y) of the depression.

5: The pliers according to claim 4, wherein the joint bolt axis (x) is offset relative to the center axis (y) of the depression in the adjustment direction (r) of the pliers mouth (7).

6: The pliers according to claim 1, wherein the jaws (5, 6) have working surfaces (23, 24) that are provided with a toothing (25, 26).

7: The pliers according to claim 6, wherein the working surfaces (23, 24) deepen, with respect to a longitudinal extent (L) of the pliers mouth (7), toward the pliers tip (34) such that an opening (37) remains in a front view of the pliers mouth (7) when the pliers (1) are closed.

8: Pliers (1) comprising two pliers arms (3, 4), which are pivotable about a rotational axis (x), and a pliers mouth (7) formed by two jaws (5, 6), wherein the pliers mouth (7) has opposing working surfaces (23, 24), in the form of a first working surface (24) and a second working surface (23), which are provided with a toothing (25, 26) over a significant part of their length viewed from a free end (48) of the jaws (5, 6) toward the rotational axis (x), and wherein pointed teeth (28) of the toothing have an orientation of the tooth tips (29) in a direction of the rotational axis (x) and other pointed teeth (28) have an orientation of the tooth tips (29) toward the free end (48) of the jaws (5, 6), wherein both working surfaces (23, 24) respectively have teeth (29) in their extent from the free end (48) of the jaws (5, 6) to the rotational axis (x), wherein said teeth have tooth tips (29) that are oriented in the direction of the rotational axis (x) and are followed by additional teeth (28) in the same working surface (23, 24), wherein the tooth tips (29) of these additional teeth are oriented toward the free end (48) of the jaws (5, 6), or vice versa, and wherein oppositely oriented groups (G1, G2, G3, G4, G5 and G6) of teeth (28) furthermore are respectively formed opposite of one another on the first and the second working surface (23, 24).

9: Pliers (1) comprising two pliers arms (3, 4), which are pivotable about a rotational axis (x), and a pliers mouth (7), wherein the pliers mouth (7) has working surfaces (23, 24) that are provided with a toothing (25, 26) with pointed teeth, and the pointed teeth (28) have, with respect to an extent of tooth tips (29) in the working surface (23, 24), an orientation in a direction of the rotational axis (x), wherein the teeth (28) furthermore have a respective angle bisector (Q), and wherein the angle bisectors (Q) extend, starting from the tooth tip (29) and facing away from the pliers mouth (7), toward the free end of the jaws (5, 6) or toward the end of the pliers mouth (7) on the joint side, wherein, viewed from a free end of the working surfaces (23, 24) of the pliers mouth (7) toward the rotational axis (x), a first group (G1) of teeth (28) is initially formed on a first working surface (24) of the pliers mouth (7), wherein the respective angle bisector (Q) of the teeth (28) of this first group extends at an incline starting from the tooth tip (29) and, facing away from the pliers mouth (7), toward the free end of the jaw (6), wherein this first group of teeth is followed by a second group (G2) of teeth (28), in which the respective angle bisector (Q) extends at an incline toward the end of the pliers mouth (7) on the joint side, and wherein this second group of teeth is followed by a third group (G3) of teeth (28), in which the respective angle bisector (Q) once again extends at an incline toward the free end of the jaw (6).

10: The pliers according to claim 1, wherein the pliers mouth (7) has working surfaces (23, 24) that are provided with a toothing (25, 26) with pointed teeth, and the pointed teeth (28) have, with respect to an extent of tooth tips (29) in the working surface (23, 24), an orientation in the direction of the rotational axis (x), wherein a penetration plane (D), which in a view, in which the rotational axis (x) is depicted in the form of a point, is depicted in the form of a line, extends through the pliers mouth (7), wherein the penetration plane (D) extends, at a maximally closed adjustment of the pliers mouth (7), at a right angle to a longitudinal center line (V) of a longitudinal slot (13) for receiving an adjustable joint bolt (2) or extends in such a way that the rotational axis (x) extends within the penetration plane (D), wherein either in the case of the longitudinal slot (13) an intersection point (P2) of the penetration plane (D) with the longitudinal center line (V) is chosen in such a way or, if the rotational axis (x) extends within the penetration plane (D), the orientation of the penetration plane (D) is chosen in such a way that a contact of opposing working surfaces takes place for the first time on a free end (50) of the jaws (5, 6) at a certain opening angle in the course of closing the pliers mouth (7), wherein the tooth tips (29) furthermore end, referred to a perpendicular (N) that penetrates the tooth tips (29), to the penetration plane (D) with different perpendicular distance (b) from the penetration plane (D) and the teeth (28) furthermore have an angle bisector (Q), which includes an acute angle (δ, ε) with the penetration plane (D), and wherein the acute angle (δ, ε) is in a region, in which the angle bisector (Q) extends within the region of the pliers mouth (7), formed between the perpendicular (N) and the rotational axis (x) on one part of the teeth (28) and between the perpendicular (N) and the free end (50) of the pliers mouth (7) in another part of the teeth (28), wherein, viewed from the free end (50) of the working surfaces (23 and 24) of the pliers mouth (7) toward the rotational axis (x), a first group (G1) of teeth (28) is initially formed on a first working surface (24) of the pliers mouth (7), wherein the acute angle (δ) of this first group of teeth is respectively formed between the perpendicular (N) and the rotational axis (x), wherein this first group of teeth is followed by a second group (G2) of teeth (28), in which the acute angle (ε) is respectively formed between the perpendicular (N) and the free end (50) of the working surfaces (23 and 24) of the pliers mouth (7), and wherein this second group of teeth is followed by a third group (G3) of teeth (28), the acute angles (δ) of which are once again formed between the perpendicular (N) and the rotational axis (x).

11: The pliers according to claim 8, wherein a fourth group (G4) of teeth (28) follows the third group (G3) of teeth (28), wherein the respective angle bisector (Q) of the teeth (28) of the fourth group extends at an incline toward the end of the pliers mouth (7) on the joint side.

12: The pliers according to claim 10, wherein a fourth group (G4) of teeth (28) follows the third group (G3) of teeth (28), wherein the acute angle (8) of the teeth of the fourth group is formed between the perpendicular (N) and the free end (50) of the working surfaces (23 and 24) of the pliers mouth (7).

13: The pliers according to claim 10, wherein groups (G1, G2, G3, G4, G5 and G6) of teeth (28) with a certain angular orientation respectively lie opposite of one another referred to the penetration plane (D).

14: The pliers according to claim 8, wherein the tooth tips (29) are with respect to the opposed position arranged offset to one another through a longitudinal center plane (E) referred to a perpendicular (N).

15: The pliers according to claim 8, wherein the second working surface (23) of the pliers mouth (7) is provided with a first group (G5) of teeth (28), in which a respective angle bisector (Q) of the teeth (28) extends at an incline starting from the tooth tip (29) and, facing away from the pliers mouth (7), toward the free end of the jaw (5), wherein said first group is followed by a second group (G6) of teeth (28), in which the respective angle bisector (Q) extends at an incline toward the end of the pliers mouth (7) on the joint side, and wherein the second group (G6) of teeth (28) has two subgroups (G6-1 and G6-2) of teeth (28), wherein the angle bisector (Q) of a first subgroup (G6-1) has a smaller incline and the angle bisector (Q) of a second subgroup (G6-2) has a greater incline, and/or wherein, the second working surface (23) of the pliers mouth (7) is provided with a first group (G5) of teeth (28), in which an acute angle (δ) is respectively formed between a perpendicular (N) and the rotational axis (x), and with a second group (G6) of teeth (28), in which an acute angle (ε) is respectively formed between the perpendicular (N) and the free end (50) of the working surfaces (23 and 24) of the pliers mouth (7), and in that the second group (G6) of teeth (28) has two subgroups (G6-1 and G6-2) of teeth (28), wherein a first subgroup (G6-1) has smaller acute angles (ε) and a second subgroup (G6-2) has greater acute angles (ε).

16: The pliers according to claim 8, wherein the pliers are configured such that a round bolt (49) can be grasped by one or more oppositely arranged and oppositely oriented teeth (28) of the first and the second working surface (23, 24) in a front region (51) facing the free end (48) of the jaws (5, 6), as well as in a rear region (52) of the pliers mouth (7) facing the rotational axis (x), wherein teeth (28) of different groups (G1, G2, G3, G4, G5 and G6) of teeth (28) are respectively engaged with the round bolt (49) in the front and the rear region, wherein the round bolt can be grasped in the rear region by two teeth (28), which are respectively assigned to one of the opposite working surfaces (23, 24) and the tooth tips (29) of which extend in opposite directions, and wherein the round bolt likewise can be grasped in the front region (51) by two teeth (28), which are respectively assigned to one of the opposite working surfaces (23, 24) and the tooth tips (29) of which extend in opposite directions.

17: The pliers according to claim 16, wherein the pliers are configured such that twofold grasping of the round bolt (49) is possible if the round bolt (49) has a diameter (e) that requires a pliers mouth opening of approximately 10 degrees for the grasping of the round bolt (49) in the front region (51) or in the rear region (52).

18: The pliers according to claim 8, wherein the orientation of the tooth tips (29) is defined by a different length of tooth flanks (47, 47′) of the respective tooth (28), wherein the longer tooth flank (47) is formed on the side of the tooth tip (29) facing away from the rotational axis (x) if the tooth tip is oriented in the direction of the rotational axis (x) and the longer tooth flank (47) is formed on the side of the tooth tip (29) facing away from the free end (48) of the jaws (5, 6) if the tooth tip (29) is oriented toward the free end (48) of the jaws (5, 6).

19: The pliers according to claim 1, wherein the pliers mouth (7) has working surfaces (23, 24) that are provided with a toothing (25, 26) and the pointed teeth (28) have an orientation in the direction of the rotational axis (x), wherein a polyline (Z, Z′) can be laid through the tooth tips (29), and wherein segments (T) of the polyline (Z, Z′) furthermore include an angle (α, β, γ) with one another and polylines (Z, Z′) lie opposite of one another in an open position of the pliers mouth, wherein each polyline (Z, Z′) has in any case two adjacent segments (T) that, pointing toward the pliers mouth (7), include an angle (α) of 170 degrees or less to, for example, 100 degrees with one another, wherein segments (T) of the other polyline (Z′, Z) lie opposite of these segments (T) and, pointing toward the pliers mouth (7), include an angle (β) of 170 degrees or more to, for example, 190 degrees with one another, and wherein each polyline (Z, Z′) contains two segments (T) that, viewed in the same direction, include an angle (γ) of 190 degrees or more with one another.

20. (canceled)
